(19) United States
(12) Patent Application Publication
(10) Pub. No.: US 2017/0025190 A1
(43) Pub. Date: Jan. 26, 2017

(54) SPHERICAL FUSION REACTOR WITH AEROGEL MATERIAL

(71) Applicant: Richard Allen Gibson, Torrance, CA (US)

(72) Inventor: Richard Allen Gibson, Torrance, CA (US)

(21) Appl. No.: 14/807,743

(22) Filed: Jul. 23, 2015

(51) Int. Cl. G21B 1/13; G21B 1/17; G21B 1/05

(52) U.S. Cl. CPC G21B 1/13; G21B 1/05; G21B 1/17

(57) ABSTRACT

A spherical nuclear fusion reactor machine is provided that uses a graphene aerogel material to enclose a fuel reaction zone. In illustrative examples described herein, the graphene aerogel material functions as a greybody material and includes a heavy noble gas such as xenon, krypton or argon or combinations thereof. The fuel reaction zone includes a radioactive isotope such as polonium-210 in addition to fusion fuel. A component of the heavy noble gas may be a radioactive isotope of xenon, Xe-135. A spherical enclosure with a reflective inner surface surrounds the fuel reaction zone and the graphene aerogel material. Magnetic field generators with rotating permanent magnets or electro-magnets and fixed electro-magnets are also provided. The magnetic field generators are external to the spherical enclosure and are configured to produce magnetic fields within the fuel reaction zone to initiate nuclear fusion and to generate a magnetic “bottle” to contain the fusion materials.

### BACKGROUND

Field of the Invention

Aspects of the invention relate to nuclear fusion reactors and, in particular, to fusion reactors employing the magnetic bottle effect.

Description of Related Art

Nuclear fusion reactors are devices that operate to generate energy by exploiting nuclear fusion reactions. Examples include Magnetic Confinement Machines that use magnetic fields to confine and energize a plasma (i.e. an ultra-high temperature, ionized gas). At present, such devices typically operate for only several milliseconds before plasma instabilities cause the heated fusion fuel to escape the magnetic field. Other examples of fusion reactors include Z-Pinch Machines where a magnetic pinch (i.e. a Z-pinch) creates the high fuel temperatures needed for fusion reactions. Z-Pinch Machines exploit the Lorentz force in which a current-carrying conductor in a magnetic field experiences a force. When an electrical current passes through the plasma, particles in the plasma are pulled toward each other by the Lorentz force and the plasma contracts. The contraction is counteracted by increasing gas pressure (and, hence, by the temperature of the plasma that increases in response to the increasing pressure). Within conventional Z-Pinch Machines, since the plasma is electrically conductive, a nearby changing magnetic field induces a current. This allows for feeding a current into the plasma without physical contact, which is important as a plasma can rapidly erode mechanical electrodes. In practical devices, this is normally achieved by placing the plasma vessel inside the core of a transformer. When current is sent into a primary side of the transformer, the magnetic field induces a current in the plasma. Currently, much of the research in Z-Pinch technology is performed using Tokomaks. Fusion has been achieved in such devices but instabilities in the plasma often render the plasma so unstable the reactors can operate only for short periods of time (e.g. milliseconds). Fusion energy produced is often less than that needed to attain a “breakeven” energy. Moreover, unstable operation in such devices can produce very energetic electrons (i.e. runaway electrons) that can physically damage the machine.

Other examples of fusion reactors include Inertial Confinement Machines where lasers or high-energy particles are directed at “pellets” containing fusion fuel. Light from a symmetrically positioned array of lasers energizes the plasma. The laser pulses are usually less than 20 nanoseconds (ns) in duration. Most of the nuclear reactions take place in a “bang time” of only 100 to 200 picoseconds (ps) and so the heated fuel material heats so rapidly it cannot move because of its inertia. In such devices: (a) laser beams or laser-produced X-rays rapidly heat the surface of the fusion target, forming a surrounding plasma envelope; (b) fuel is compressed by a blowoff of hot surface material; (c) during the final part of the capsule implosion, the fuel core can reach twenty times the density of lead and ignites at 100,000,000° C.; and (d) thermonuclear burn spreads rapidly through the compressed fuel, yielding many times the input. However, to make Inertial Confinement fusion practical, there are many significant engineering issues. Thus far, the lasers typically fire one shot and, although the energy produced has exceeded the energy input, major technical challenges remain to produce energy continuously using such techniques in a power plant. Moreover, it is not easy to out-couple the energy to make electrical power.

Still other examples of nuclear fusion reactors include Magnetic Mirror Machines wherein a charged particle moving in a magnetic field experiences a Lorentz force that causes it to move in a helical (i.e. corkscrew) path along a magnetic field line. The radius of the circle that the particle describes is known as the radius of gyration. As the particle enters a region of denser magnetic field lines (i.e. the particle enters a field gradient), the combination of the radial component of the fields and the azimuthal motion of the particle results in a force against the gradient in the direction of lower magnetic field. This force can reflect the particle, causing it to decelerate and reverse direction, thus containing or constraining the particle within a “magnetic bottle” or “bottle-like” field. The plasma is heated by introduction of electromagnetic (EM) radiation, for example, cyclotron radiation from a radio frequency antenna or by injection of high-energy particles into the magnetic mirror.

Various features described herein are directed to providing significant improvements to nuclear fusion reactor designs and technologies, particularly within technologies that exploit magnetic bottles, magnetic mirrors or similar effects.

### SUMMARY

In an exemplary embodiment, a nuclear fusion reactor apparatus, device or machine includes: a fuel reaction zone and a graphene aerogel material enclosing at least a portion of the fuel reaction zone. In an illustrative embodiment, the graphene aerogel material acts as a greybody and is adapted to function as a radiation frequency converter and a thermal capacitor, which stores sufficient energy (in, e.g., multiple machines) to provide the electrical output power of the plant. The graphene aerogel material can be at least partially infused with a heavy noble gas (HNG) such as xenon, krypton or argon or combinations thereof. In the illustrative embodiment, the graphene aerogel material has high resistance to the flow of heat via thermal conductance and thermal convection and substantially absorbs the intermittent high frequency electromagnetic radiation produced in the fuel reaction zone while fusion reactions are occurring and converts it to a continuous stream of low frequency electromagnetic radiation with a spectral radiance curve that is similar to that produced by the sun. A substantially spherical enclosure can be provided with an inner surface that substantially reflects the low frequency radiation that surrounds the fuel reaction zone and the graphene aerogel material. The resistance to radiative heat flow from the greybody provided by this mirrored surface works in conjunction with the thermal capacitance of the greybody zone to produce an exponential decay of the temperature in the greybody following fusion reactions. The “time constant” for this exponential decay can be proportional to the product of the thermal capacitance of the greybody (roughly, the sum of the products of the mass of the individual materials in the greybody and the specific heat capacity of those materials) and the resistance to radiative heat flow from the greybody provided by the mirrored spherical enclosure. The fuel reaction zone can include a radioactive isotope such as polonium-210 and the HNG can include a radioactive isotope of xenon, i.e., xenon-135. These isotopes can function to facilitate the breakdown of the fusion fuel into a plasma at preferred high gas pressures (near one atmosphere and higher) and initially position the plasma to best advantage at the center of the fuel reaction zone.

Magnetic field generators having at least one rotating magnet and at least one fixed electro-magnet may also be provided. In the illustrative embodiment, two sets of magnetic field generators are mounted externally to the spherical enclosure on oppositely opposed sides of the enclosure. The fixed electro-magnets produce a static magnetic field within the enclosure. The poles of the fixed electro-magnets are aligned along an axis extending through the center of the fuel reaction zone. The poles of the fixed electro-magnets are aligned north to south on opposing sides of the enclosure so that their fields add inside the fuel reaction zone. In this manner, a static magnetic “bottle” or “bottle-like” fuel containment field is produced. The fixed electro-magnets may include superconducting coils. The rotating magnets spin on axes that are aligned with the fixed electro-magnets and the center of the fuel reaction zone. To stabilize and support the spinning magnet assemblies, the magnet assemblies are configured for rotating in the horizontal plane with the mechanical support and stabilization assembly as well as the electric motor drive located beneath the magnet assemblies.

In use, the rotating magnets on either side of the enclosure rotate at the same rotational speed and are synchronized so to be alternately aligned north-south and then south-north or vice versa during every cycle of the rotation. The magnets operating in concert thus produce a magnetic field that is largely static except when the rotating magnets align across the enclosure, north-south or south-north. When the rotating magnets come into and out of alignment, there is be a rapid, large change in the magnetic field along the alignment axis, producing large changes in the magnetic flux in the fuel zone. The electric fields generated then feed large amounts of energy into the fuel gas plasma generated. If the average temperature in the greybody zone is sufficiently high that the physical integrity of the graphene aerogels might be compromised, the rotational speed of the magnets may be reduced by reducing the power to the electric motor drive or by other methods. For the rotating assembly, this can have the effect of both reducing the maximum rate of change of the dynamic magnetic field and, concomitantly, the frequency with which it is applied. This reduces the rate of fusion reactions or eliminates them altogether and reduces the rate of heat transfer to the greybody or substantially eliminates it. The rotating magnets may be integrated with a substantially large moment of inertia cylinder to reduce the size of the electric motors and associated electrical power supply assemblies employed to rotate the magnet assemblies. Magnetic hose material centered along the axis between the magnetic field generators and an outer perimeter of the spherical enclosure may be used to collimate and/or re-position at least a portion of the magnetic fields. The material may also be used, if necessary, to divert the static field produced by the superconducting magnet around permanent magnets (if used to produce the dynamic field) to preclude possible demagnetization of the permanent magnets.

In another exemplary embodiment, a nuclear fusion reactor system includes: a plurality of individual nuclear fusion reactor apparatus, device or machines, each having a fuel reaction zone and a graphene aerogel material enclosing at least a portion of the corresponding fuel reaction zone of the individual nuclear fusion reactor apparatus. In an illustrative example of the system, at least one magnetic field generator is installed between pairs of adjacent nuclear fusion reactor apparatus. The individual nuclear fusion reactor apparatus may be arranged in a loop (such as a circular or elliptical loop) of sufficiently large radius that the operational characteristics of the magnetic fields are not substantially affected. The temperature of the greybody (and thus the flow of heat to the balance of plant, e.g., circulating high pressure water to a turbine generator and a cooling tower heat sink) of the individual machines will vary with time. Thus, it may be desirable to time-phase the heat output of several of the machines to ensure steady heat flow to an individual steam turbine Rankine cycle machine to optimize its engineering design and produce steady electrical power from the turbine generator.

In yet another exemplary embodiment, a method for obtaining energy from nuclear fusion is provided that uses a nuclear fusion reactor apparatus, device or assembly. The method includes: initiating a nuclear fusion reaction within a fuel reaction zone to generate energy; at least some of the energy passes through a graphene aerogel material enclosing at least a portion of the fuel reaction zone; and heating a material external to the graphene aerogel material using the energy passed through the graphene aerogel material. In an illustrative example, the material external to the graphene aerogel material that is heated is pressurized water. The high-pressure water can then transfer the heat to a Rankine cycle loop to produce steam that drives a turbine generator to produce electricity. In some examples, the graphene aerogel material is at least partially infused with an HNG. A nuclear fusion reaction may be initiated within the fuel reaction zone by applying a magnetic field to the fuel reaction zone that includes both static and dynamic magnetic field components.

System and method examples are described in detail below.

### BRIEF DESCRIPTION OF THE DRAWINGS

Referring now to the drawings in which like reference numbers represent corresponding parts throughout and in which:

FIG. 1 provides an overview of selected components of an exemplary spherical fusion apparatus, device or machine that exploits graphene aerogels;

FIG. 2 provides a stylized illustration of an exemplary nuclear fusion power plant employing a spherical fusion apparatus such as the one of FIG. 1;

FIG. 3 provides a stylized illustration of an exemplary spherical fusion apparatus, particularly illustrating additional functional components thereof;

FIG. 4 provides a stylized illustration of selected components of an exemplary nuclear fusion power plant having a linear set of spherical fusion machines;

FIG. 5 provides a stylized illustration of selected components of another exemplary nuclear fusion power plant having a loop of spherical fusion machines;

FIG. 6 provides a broad overview of an exemplary procedure to obtain energy using a nuclear fusion reactor apparatus exploiting graphene aerogels;

FIG. 7 illustrates further aspects of the exemplary procedure of FIG. 6;

FIG. 8 illustrates still further aspects of the exemplary procedure of FIG. 6;

FIG. 9 illustrates yet other aspects of the exemplary procedure of FIG. 6;

FIG. 10 illustrates additional aspects of the exemplary procedure of FIG. 6;

FIG. 11 illustrates still more features of the exemplary procedure of FIG. 6;

FIG. 12 summarizes selected features of an exemplary nuclear fusion reactor apparatus in block diagram form; and

FIG. 13 summarizes further aspects the exemplary nuclear fusion reactor apparatus of FIG. 12 in block diagram form.

### DETAILED DESCRIPTION OF ILLUSTRATED EMBODIMENTS

In the following descriptions, specific details are given to provide a thorough understanding of the various aspects of the disclosure. However, it will be understood by one of ordinary skill in the art that the aspects may be practiced without these specific details. The word “exemplary” is used herein to mean serving as an example, instance, or illustration. Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation.

### Overview of Exemplary Nuclear Fusion Reactor Apparatus, Device or Machine

Aspects of the nuclear fusion reactor described herein exploit graphene. Graphene and its derivatives such as graphene aerogels are used herein to provide fusion-powered plants producing electricity using otherwise conventional steam powered turbine generators. That is, the heat produced by the nuclear fusion reaction is delivered to high-pressure water circulating around the perimeter of the machine and used to produce steam in a Rankine cycle loop that drives a turbine generator to produce electricity in much the same way as in current nuclear (fission) plants. No exotic or untested means of extracting the energy to produce electricity are required. The approach described herein may work best on fusion reactions (such as He-3 on He-3 or Deuterium on He-3) where the fusion reaction products are all charged (sometimes called aneutronic reactions) and thus can be contained by the intense magnetic fields produced by the machine. Alternative energy extraction methods that others have proposed appear to be primarily focused on having the charged fusion products doing work directly on an electrostatic field, thus transferring the kinetic energy of the charged particles directly to electrical power. These alternative extraction methods present a somewhat speculative and unproven means of efficiently extracting the energy of the fusion reactions and may require much development work.

For reactions that produce neutrons (such as Deuterium on Tritium and Deuterium on Deuterium), as much as 80 percent of the energy produced is carried away from the plasma by neutrons, which have no electrical charge and are therefore unaffected by magnetic fields. The approach described herein significantly slows the neutrons in a “blanket” of graphene aerogel structures infused with a heavy noble gases (HNG), for example xenon, krypton, radon or argon or combinations thereof and graphene aerogel structures. An isotope of xenon, Xe-135, may be used as one of the components of the HNG. It has a neutron cross-section of 2.5 million barns for “thermal” (low energy) neutrons. However, a significant number of the high energy neutrons may escape the HNG/carbon blanket and impact the surrounding metallic structures causing transmutations in the metals. Moreover, no matter what the fusion fuel, the bremsstrahlung x-rays resulting from the decelerating high energy charged particles produced during the fusion reactions are specifically targeted by this design and can be substantially absorbed by a graphene aerogel/HNG blanket within the machine. Additionally, any of the (relatively small number of) high energy charged particles produced during the fusion reactions that escape the magnetic bottle will have their energy absorbed in the graphene aerogel/HNG blanket.

In the approach described herein, fusion reactions occur intermittently but at a regular time interval when dynamic magnetic fields come into and out of alignment. The heat produced during the period during in which fusion reactions occur can be stored in the graphene aerogel/HNG blanket, which acts as a “thermal capacitor” with relatively high thermal resistance to radiative heat transfer and, thus, releases heat energy slowly during the time interval in which fusion is not occurring, maintaining the high temperature in the graphene aerogel/HNG blanket. In use, the temperature of the graphene aerogel/HNG blanket incrementally rises on each heat-producing cycle. When the average temperature is sufficiently high that the physical integrity of the carbon elements (graphene aerogels) might be compromised, both the maximum rate of change of the dynamic magnetic field and, concomitantly, the frequency with which it is applied can be reduced. This will reduce the rate of fusion reactions or eliminate them altogether and reduce the rate of heat transfer to the carbon elements or substantially eliminate it.

Additionally, the energy produced by the bremsstrahlung during fusion process is transformed by the processes described herein to electromagnetic energy with wavelengths largely greater than 100 nanometers (nm) and have a spectral radiance curve similar to that of the sun. Thus, the heat energy produced by the fusion reaction can be stored and released at a much slower rate than it is produced, permitting a continuous flow of heat from each of the fusion reactors to the electrical generators. If necessary, heat delivery from the individual fusion reactors is sequenced such that the heat flow to the steam generators and concomitant electrical power production is continuous and steady, ensuring optimization of the Rankine steam cycle engineering design. The largely spherical outer perimeter of the machine has an inner layer of material that reflects some of this electromagnetic energy back toward the HNG/carbon blanket of the machine and aids in maintaining high temperatures within the blanket between fusion events. In use, the temperature in the reflecting material is maintained significantly below the melting point of the material by ensuring high-pressure water circulating around the perimeter has sufficiently high flow and low temperature to transfer the heat out of the reflecting material at a sufficiently high rate. The electromagnetic energy which is not reflected passes through the reflecting material and a substantial amount of the heat produced in the fusion reactions is transferred to the high pressure water flowing in the outer perimeter of the machine and then on to a steam generator which generates electrical power in a conventional Rankine steam cycle machine. The efficiency of these Rankine cycle machines is about 30 to 40%. So about 30 to 40% of the energy produced in the fusion reactions and successfully delivered to the steam cycle machine is typically converted to electricity. The “waste heat” is delivered to an arrangement of cooling towers which are the heat “sink” for the plant. This may be an array of cooling towers exchanging heat with ambient air driven through the cooling towers by high flow fans.

Various methods of containing and heating the fusion gases at the center of the machine might be employed. In operation, the fusion gases comprise a highly ionized plasma state. The method chosen herein for containing the highly ionized fusion fuel gas is a magnetic “bottle” produced by a high intensity magnetic field formed along a central axis of the spherical machine. Fixed electro-magnets (which might comprise superconducting materials) that have axes aligned with the central axis are used to generate the static field. One approach to energizing the fusion fuel gas is electromagnetic induction. A time-varying (dynamic) magnetic field, produced by magnets operating at high rotational speeds is superimposed on the (static) magnetic field produced by the superconducting magnets. This approach completely (or at least substantially) eliminates the need for complex high frequency, high power electrical circuits and elaborate switching technologies to feed energy into the dynamic magnetic field.

An emerging technology incorporating a process of layering graphene with substrate material has demonstrated remarkable increases in tensile strength of the composites with only a few layers of graphene. This technology may be applied to increase the tensile strengths of the cores of the rotating electromagnets and/or permanent magnet materials, increasing the rotational speeds with which they can operate and enhancing the fusion fuel heating capability of the rotating magnets. The high-pressure water coolant is pumped around a “primary” circuit by powerful pumps. After picking up heat as it passes around the perimeter of the mirrored spherical enclosure, the high-pressure water transfers heat in a steam generator to water in a lower pressure secondary circuit, creating superheated steam for use in the steam turbine. The cooled primary coolant is then returned to the outer perimeter of the machine to be heated again.

Turning to the figures, exemplary embodiments will now be described.

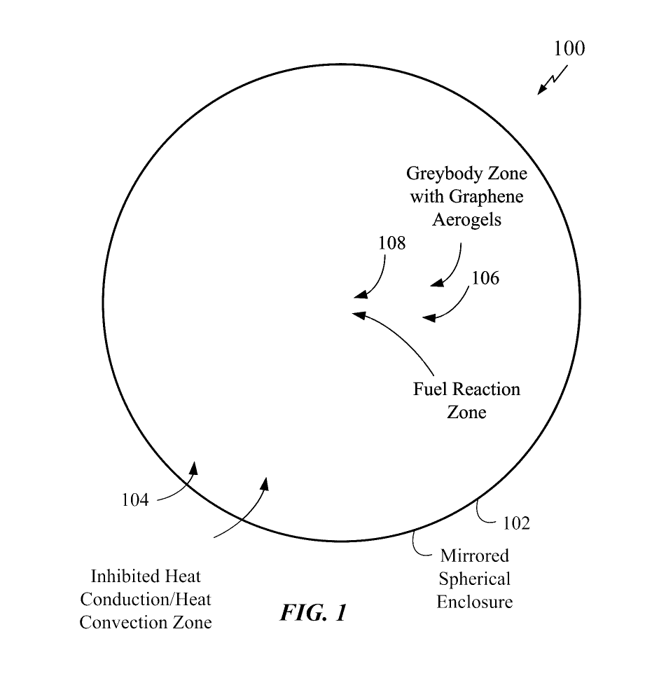

FIG. 1 provides an overview of selected components of an exemplary spherical nuclear fusion reactor apparatus, device or machine 100. Note that other terms may be used where appropriate to refer to the apparatus of FIG. 1 and other devices described herein, such as assembly, construction, mechanism, instrument or equipment. Briefly, as shown in FIG. 1, a mirrored spherical enclosure 102 surrounds an inhibited heat conduction/heat convection zone 104, which in turn surrounds a greybody zone 106 that includes at least some graphene aerogel material. (Note that zone 104 is referred to herein as an inhibited heat conduction/heat convection zone because there is almost no heat transfer via conduction and convection within the zone and substantially all the heat generated in the fuel reaction zone is transferred at the same average rate it is being produced through zone 104. Zone 104 may be alternatively referred to as a “low frequency radiation heat flow zone” or by using other suitable terminology.) The inhibited heat conduction/heat convection zone 104 includes, in some examples, at least some aerogels that are transparent to electromagnetic radiation with a spectral radiance curve that is similar to that of the sun but that have high resistance to heat flow via conduction or convection. These might be silica aerogels, silica/graphene aerogels or graphene aerogels that largely transmit electromagnetic radiation in the wavelength range as described in the previous sentence.

At the center of the greybody zone, a fuel reaction zone 108 generates energy via nuclear fusion reactions. For example, within fuel reaction zone 108, a fuel composed of isotopes of hydrogen (H) or the isotope helium-3 are fused to produce energy. To this end, the fuel gas is raised to a sufficiently high kinetic energy/“temperature” to initiate fusion reactions. This may be achieved by generating strong dynamic magnetic fields within the fuel reaction zone via electromagnetic induction (using magnetic field generators not shown in FIG. 1). The fuel reaction zone 108 can include a radioactive isotope such as polonium-210 and the greybody zone 106 may contain a radioactive isotope of xenon, i.e. xenon-135 as an HNG component. These isotopes facilitate the transformation of the fusion fuel into a plasma state at preferred high gas pressures (near one atmosphere and higher) and help to initially position this plasma to best advantage at the center of the fuel reaction zone. When the dynamic magnetic field in the fuel reaction zone is at its peak, the fuel gas will be in the plasma state. It can be maintained in the plasma state by the continual introduction of an alpha-particle emitter such as Po-210 into the fuel reaction zone. In the plasma state, the fuel is constrained to the center of the enclosure by static magnetic fields (also generated by the magnetic field generators not shown in FIG. 1), which create a magnetic “mirror” or “bottle” or “bottle-like” field at or near the center of the sphere. Although not shown in FIG. 1, pressurized water is pumped around the outside perimeter of the spherical enclosure 102. It is heated by the reactor and the heat is transferred to a lower pressure Rankine cycle loop where it is used to generate steam for spinning turbines to thereby produce electrical power.

In the particular example of FIG. 1, the greybody zone or region 106 is substantially concentric to the inner fuel reaction zone 108 and the inhibited heat conduction and convection zone 104 is substantially concentric to the greybody zone 106. In at least some examples where the starting pressure is about one atmosphere, the diameter of the fuel reaction zone is about 1 meter (m); the outer diameter of the greybody zone is about 3 m; and the diameter of the mirrored enclosure 102 is about 4 m. (If the starting pressure is higher, the dimensions can be smaller.) A primary function of the greybody zone is to capture high frequency (i.e. ultraviolet and x-ray) electromagnetic radiation produced in the fuel reaction zone while fusion is occurring and convert it to heat. The greybody zone is provided with a sufficient amount of black graphene aerogel material (or other suitable aerogel material) infused with HNG to significantly block convection and conduction of heat from the fuel reaction zone while also absorbing the high frequency electromagnetic radiation produced in the fuel reaction zone and converting it to heat. (Note that, herein, a “greybody” is a body that emits radiation in substantially constant proportion to a corresponding black-body radiation.)

In use, at the outer boundary of the greybody zone 106, the effective average temperature is about 5000K. The materials in the greybody zone effectively continuously emit electromagnetic radiation incandescently. The spectral radiance of this electromagnetic spectrum is similar to that produced by the sun, emitting most of its electromagnetic radiation at wavelengths greater than 100 nm That is, a sufficient and efficacious amount of graphene aerogel material, partially infused with HNG, is provided and arranged within the greybody zone to absorb high frequency radiation produced as a result of the fusion reactions to yield an average temperature of about 5000 K (in at least some examples) at the outside perimeter of the greybody reaction zone in steady-state operation of the machine. As can be appreciated, the amount of graphene aerogel material to be used will depend on the characteristics of the particular graphene aerogel, the core temperature of the reactor while it is operating, and various other factors such as the size of the greybody zone, the resistance to radiative heat flow from the greybody zone by the mirrored inner surface and can be determined, for a particular apparatus configuration, via otherwise routine modelling, testing and/or experimentation.

The greybody zone 106 takes advantage of certain advantageous characteristics of graphene (e.g. high melting point, strong material, deformable, excellent compression recovery, etc.) that are discussed more fully below. Note that at least some graphene aerogel can also be provided within the fuel reaction zone itself or within the inhibited heat conduction/heat convection zone, and so the use of graphene aerogel is not limited to the greybody reaction zone. Any layers or portions of graphene aerogel provided within the fuel reaction zone 108 may be infused with fuel to help feed the fusion reaction and substantially inhibit the flow of fuel out of the fuel reaction zone 108. Layers or portions of graphene aerogel within the greybody reaction zone 106 may contain HNG to reduce thermal conduction.

The inhibited heat conduction/heat convection zone 104 is configured to be transparent to most of the low frequency electromagnetic radiation produced by the high temperature greybody zone while substantially blocking heat transfer by conduction and convection. To this end, the inhibited heat conduction/heat convection zone 104 may contain aerogels that are transparent to visible light such as silica aerogels. Note that silica aerogels adsorb gases (with a surface area=600-1000 m²/g and with pore volumes of 2.96 cm³/g), and it may be possible to “tailor” them to adsorb HNG, thus making them well-suited for use as an inhibited heat transfer material. Alternatively, zone 104 employs a synthesis of silica and graphene aerogels configured to be transparent to most of the low frequency electromagnetic radiation produced by the high temperature greybody zone while also exhibiting some of the more advantageous mechanical characteristics of the graphene aerogels, such as high melting point, excellent compression recovery, etc. That is, a sufficient and efficacious amount of a silica aerogel or silica/graphene aerogel is provided and arranged within the inhibited heat conduction/heat convection zone 104 to substantially block all heat transfer by heat conduction and convection from the materials in the greybody zone 106 into zone 104 while substantially transmitting electromagnetic radiation with frequencies produced by an incandescent body at a temperature of 5000K. As can be appreciated, the amount of aerogel material to be used in the inhibited heat transfer zone will depend on the characteristics of the particular aerogel and various other factors such as the size of the inhibited heat transfer zone, etc., and can be determined, for a particular apparatus configuration, via otherwise routine modelling, testing and/or experimentation. Note that if, during development of a particular embodiment of the fusion machine, it is found that heat convection is negligible in zone 104, then the zone can be substantially filled with an HNG such as xenon without aerogels.

The mirrored inner surface of spherical enclosure 102 employs polished metal (e.g., aluminum) to substantially reflect all electromagnetic radiation with wavelengths greater than 100 nm and less than 20 μm emanating from the greybody zone back toward the greybody zone, thus reducing the radiative heat flow of low frequency electromagnetic radiation from the greybody zone 106. The resistance to radiative heat flow produced by the mirrored inner surface serves to maintain the temperature of the materials in the greybody zone at a higher temperature than they otherwise would be. Moreover, the radiative resistance to heat flow from the greybody zone 106 is relatively high and, thus, heat energy from the greybody zone is released relatively slowly during the time interval in which fusion is not occurring. This acts to maintain the high temperature of the materials in the greybody zone. Thus, the heat energy produced by the fusion reaction can be stored and released at a much slower rate than it is produced, permitting a largely continuous, steady flow of heat from each of the fusion reactors to the electrical generators.

In some embodiments, if appropriate, heat delivery from a multiplicity of individual fusion reactors can be sequenced such that the heat flow to the steam generators and concomitant electrical power production is extremely steady, ensuring optimization of the Rankine steam cycle engineering design. The temperature in the reflecting material is maintained significantly below the melting point of the material by ensuring high-pressure water circulating around the perimeter has sufficiently high flow and low temperature to transfer the heat out of the reflecting material at a sufficiently high rate. The electromagnetic energy which is not reflected then passes through the mirrored spherical enclosure 102 and a substantial amount of the heat produced in the fusion reactions is transferred to the high pressure water flowing in the outer perimeter of the machine and then on to a steam generator which generates electrical power in a conventional Rankine steam cycle machine. That is, a polished metal which substantially reflects all electromagnetic radiation with wavelengths between 100 nm and 20 μm is provided along the inner surface of enclosure 102. The spherical enclosure can be formed of any suitable non-magnetic metal (including aluminum) or it may be a high-strength plastic material. (Glass or ceramic would likely be too fragile for the enclosure.) As can be appreciated, the type and amount of polished metal to be used will depend on the characteristics of the particular materials or combinations of materials comprising the mirrored spherical enclosure and on various other factors such as the size of the enclosure and can be determined, for a particular apparatus configuration, via otherwise routine modelling, testing and/or experimentation. Along the axis of the magnetic fields, the mirrored spherical enclosure is configured to have openings to ensure that the magnetic fields can penetrate, substantially unabated, into the machine. Glass or ceramic material is non-magnetic and thus can be used as a “window” for the magnetic fields to enter the fuel reaction zone without significant attenuation or heating of the material.

Outside the mirrored spherical enclosure, a sheath is provided (not shown in FIG. 1) for containing flowing high-pressure water around the mirrored spherical enclosure 102 and for transferring the heat produced by the machine via the enclosure to the water. A structure (not shown in FIG. 1) placed outside the mirrored spherical enclosure is used to house the machine. It may be constructed of any suitable material such as a non-magnetic metal or high strength structural plastic that is sufficiently rigid and robust to contain the components shown in FIG. 1 during routine operation of the nuclear reactor.

Although not shown in FIG. 1, the spherical enclosure may also comprise non-magnetic steel or other metals incorporating graphene. A coating of graphene just a few atoms thick can result in a multi-fold increase in the strength of many materials. These materials may be incorporated in the mirrored spherical enclosure or the outer structure to strengthen them, especially to keep them from being forced outward by any shock wave created with the onset of fusion within the core of the reactor. Dielectric non-magnetic windows (not shown in FIG. 1) may be located along the magnetic axis of the machine, centered with the fuel reaction zone 106 to substantially pass the static and dynamic magnetic fields into the machine with minimal loss in intensity.

Thus, a spherical fusion apparatus or machine is provided that exploits aerogels that greatly inhibit conduction and convection of heat. Aerogels are effective heat conduction insulators because they are composed almost entirely of gas (and gases, particularly HNG's, are very poor heat conductors). Aerogels are also effective convective inhibitors because the gas cannot circulate through the lattice structure of the aerogel. Herein, the term “aerogel” generally refers to a solid material of extremely low density, produced by removing the liquid component from a conventional gel. For example, an aerogel may be a synthetic porous ultralight material derived from a gel where the liquid component of the gel has been replaced with a gas, resulting in a solid with extremely low density and low thermal conductivity. Aerogels can be made from various chemical compounds. In some examples, aerogels are produced by using supercritical drying to extract the liquid component of the gel, thereby allowing the liquid to be slowly dried away without causing the solid matrix in the gel to collapse, as might occur with conventional evaporation. Some aerogels are produced from silica gels, others are based on alumina, chromia, tin dioxide or carbon. Note, however, that an aerogel is not a designated material with a set chemical formula. Rather, the term is used to refer to any and all materials that meet the general definition, noted above, or the following alternative definition: a gel comprised of a microporous solid in which the dispersed phase is a gas.

Recently, graphene aerogels have been developed that are well suited for use within the spherical fusion machine of FIG. 1. For example, a graphene aerogel has been recently developed that weighs just 0.16 milligrams per cubic centimeter (a cubic meter weighs just 160 grams (5.6 ounces)) and has superb elasticity and absorption. See, “Solid carbon, springy and light,” Nature 494, 404 (28 Feb. 2013) doi:10.1038/494404a.) (Note that a gram of activated charcoal carbon can have a surface area in excess of 500 m², with 1500 m² being readily achievable. Graphene aerogels have even higher surface areas than activated charcoal carbon.) The melting temperature of graphene is the highest of any known substance. Graphene aerogels are also extremely “black,” with one layer of graphene reflecting only 0.3% of radiation between 250 nm and 14.3 microns (μm). Graphene is the strongest material (or among the strongest materials) ever tested, with an intrinsic tensile strength of 130 gigaPascals (GPa) and a Young's modulus (stiffness) of 1 teraPascal (TPa) (150,000,000 pounds per square inch (psi)).

As already explained, the graphene aerogel infused with HNG used in the greybody reaction zone 106 acts (as a “greybody”) to absorb the electromagnetic (radiant) energy coming from the fusion reaction and convert most of it to visible radiation, which is then substantially reflected by the mirrored surface 102 on the interior of the sphere. (Note that Xenon is a good absorber of x-rays, which are produced during the fusion reaction. Note also that graphene and graphene aerogels are expected to copiously adsorb UV light. Lampblack is a form of carbon that is one of the best known absorbers of all frequencies of light and so an object coated with lampblack can be made to function as a black body. Since lampblack and graphene are different forms of carbon, it is expected to be feasible to synthesize a combination of the two materials in an aerogel.) Additionally, as already noted, the mirrored enclosure 102 can be coated with layers of graphene to strengthen it as long as it does not significantly compromise its reflective properties. Graphene is extremely strong and the graphene aerogel has the characteristic that it can compress many times to about 10% of its original size and return to its original size. It may be advantageous to manufacture aerogels that preferentially adsorb different gases so that the aerogels can be used to separate different gases and preferentially locate them in different parts of the fusion machine. This is particularly advantageous for the graphene aerogel material used within the greybody zone 106 and the optically transparent aerogels in the inhibited heat conduction/heat convection zone. It would make it feasible to largely segregate the HNG (which greatly inhibits heat conduction) and the fuel gases (i.e. isotopes of hydrogen, helium-3, etc.))

Although not shown in FIG. 1, but explained in detail below, various rotating permanent magnets or electro-magnets are (in some examples) mounted outside the mirrored enclosure 102 to generate strong dynamic magnetic fields to trigger fusion. To keep the permanent magnets or electro-magnets from deforming at high rotational speed, it may be advantageous to coat graphene around the perimeter of the magnetic material of the permanent magnets or the core for winding the electrical coils for the electro-magnet. The enormous tensile strength of the graphene permits extremely high magnet rotational speeds, which are advantageous to maximize power delivered to the fuel reaction zone. Alternatively, rather than using a rotating permanent magnet, the same function may be implemented using an electro-magnet wound around a carbon core infused with graphene. Electrical connections similar to the “brushes” used in DC motors are configured to slide around two circular or elliptical metal rings (one for the +connection and one for the −connection of the electro-magnet coil) connected to a high current DC power supply to provide the current for the electromagnet. The DC power supply may be a “homopolar generator” which provides very high currents at relatively low voltages.)

Some of the features of the spherical fusion machine of FIG. 1 are summarized as follows:
1. The machine has spherical geometry with fusion fuel positioned at its center.
2. Fuel gases are largely ionized and then heated inductively with electromagnetic energy produced by rapid changes in the magnetic flux produced by rotating permanent magnets or electro-magnets exterior to the spherical structure (and described below).
3. Radial expansion of the heated fuel is inhibited by static magnetic fields along an axis of the sphere generated by electromagnets exterior to the spherical structure (and described below) and by a magnetic “bottle” created by the static fields.
4. The composite magnetic field comprises both a strong axial (static) magnetic field as well as a smaller time-changing (dynamic) component.
5. The reactor design serves to confine kinetic energy generated and heat produced initially to a relatively small volume at the center of the machine. This sets up the following sequence of event in the fuel reaction zone 108:
   a. Create a highly conducting plasma at the center of the fuel reaction zone 108 using Po-210 or another alpha-emitter. The plasma is confined to the center of the sphere by an intense static magnetic field prior to energy input to the fuel gas to localize the energy flow from the changing magnetic flux.
   b. Transfer the heat/kinetic energy over to the fuel gas that is collocated at the center, creating a partially ionized plasma in the fuel gas in a relatively small volume of the fuel reaction zone
   c. Inductively heat the fuel gas until it is largely ionized and energized in a location centered on the initial plasma formed but significantly larger in volume, encompassing sufficient volume to produce the fusion energy for efficacious operation of the machine.
   d. Continually maintain, as necessary, the fuel gas in a highly ionized (plasma) state so that it can be constrained to the fuel reaction zone by the intense static magnetic field. This may be accomplished by periodically feeding Po-210 into the center of the fuel reaction zone.
6. The reactor design serves to inhibit loss of heat from the energized fuel by minimizing convection, conduction, and radiative heat losses from the fuel so as to:
   a. Inhibit heat convection by using aerogel structures outside the fuel heating zone, including graphene aerogels, which greatly inhibit the flow of ionized and neutral gases outward from the center.
   b. Inhibit heat conduction by surrounding the heated fuel with aerogels infused with HNG.
   c. Inhibit radiative losses by utilizing HNG-filled graphene aerogels as greybodies to absorb radiation in the area near the fuel reaction zone such that the machine converts most of the radiation produced by the fusion reactions (in the ultraviolet and x-ray portion of the electromagnetic spectrum) to lower frequency electromagnetic radiation with a spectral radiance curve similar to that of the sun (with wavelengths largely between 100 nm and 20 μm).
   d. Provide sufficiently high radiative heat flow resistance from the greybody by significantly reflecting the lower frequency electromagnetic radiation by having the inner-mirrored surface work in conjunction with the large thermal “capacitance” of the greybody zone to produce a slow decay of the temperature of the greybody between fusion reactions. This feature together with that described in item c. leads to substantially capturing the energy produced during fusion and converting it to a substantially continuous flow of thermal energy from the machine in a form usable to produce electricity by conventional means.
   e. Sequence, if necessary, heat delivery from the individual fusion reactors such that the heat flow to the steam generators and concomitant electrical power production is continuous and steady, ensuring optimization of the Rankine steam cycle engineering design

### Further Details Regarding Exemplary Spherical Nuclear Fusion Reactor Apparatus

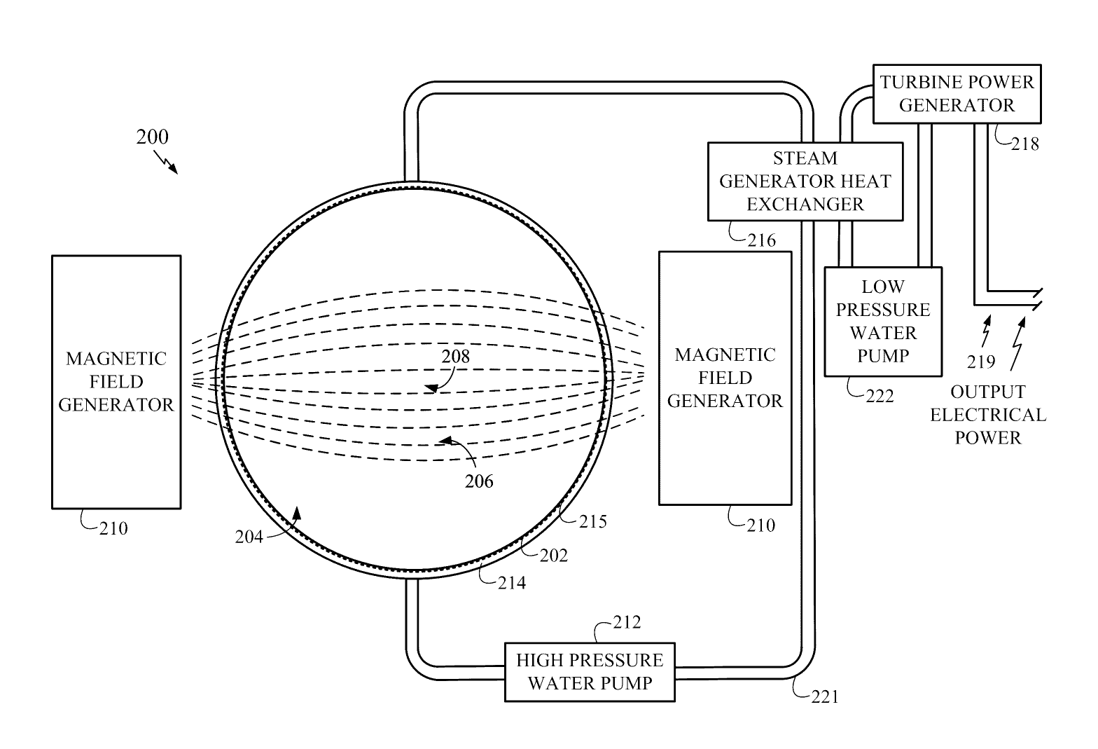

Turning now to FIG. 2, additional features of an exemplary spherical fusion apparatus or machine 200 are shown including a pair of magnetic field generators 210 for generating magnetic fields within the fusion machine, particularly within a fuel reaction zone 208, by an amount sufficient to trigger fusion reactions in the fuel and thereby generate heat, which may be used to heat pressurized water obtained from a high pressure water pump 212. Note that the magnetic field may also extend through portions of a greybody zone 206 and an inhibited heat conduction/heat convection zone 204. The perimeter of the mirrored spherical enclosure 202 operates at a high temperature, e.g. 500° C., but well below the yield point temperature of the mirror material (e.g., polished aluminum). The pressurized water is pumped through a suitable sheath 214 mounted around the mirrored enclosure 202. The water is pressurized by an amount sufficient so that it does not boil. The high pressure water is pumped in a loop by a high pressure water pump 212. An adjacent low pressure water loop is configured as a Rankine cycle machine and employs a low pressure water pump 222. The heated high-pressure water largely transfers its heat into a steam generator heat exchanger 216, which produces high pressure steam in the low water pressure loop. The high-pressure steam drives a turbine power generator 218 to generate output electrical power 219 and to cool the steam until it condenses to water. The water may be further cooled by cold water pumped in from an air/water cooling tower (not shown) and then recirculated by a pump through the low pressure water loop. The cooled high pressure water is then fed back to the water sheath 214 via a return conduit 221.

With this arrangement, a significant amount of energy can be transferred to the fuel in the fuel reaction zone 208 via EM induction from magnetic field generators 210. The combination of this and the action of the static magnetic field in confining the ionized fuel in the magnetic “bottle” and the high resistance to heat flow created by the graphene aerogels infused with HNG in the greybody zone 206 creates ultra-high “temperatures” in the fuel reaction zone. The fuel temperature/kinetic energy reached within the fuel reaction zone is thereby sufficient to cause the fuel to fuse, creating fusion power. The bremsstrahlung x-rays resulting from the decelerating high energy charged particles produced during the fusion reactions produce high frequency radiation, which propagates outward into the greybody zone 206.

A primary function of the greybody zone is to capture high frequency (ultraviolet and x-ray) electromagnetic radiation produced in the fuel reaction zone and convert it to heat. The greybody zone is provided with a sufficient amount of black graphene aerogel material (or other suitable aerogel material) infused with HNG to significantly block convection and conduction of heat from the fuel reaction zone while also absorbing the high frequency electromagnetic radiation produced in the fuel reaction zone and converting it to heat. As fusion reactions occur in the fuel reaction zone, the temperature of the materials in the greybody zone rises, producing low frequency electromagnetic radiation via incandescence. When the dynamic magnetic fields are not aligned there is no energy input to the fuel reaction zone and the fusion reactions do not occur. In that state, the temperature in the greybody zone 206 drops approximately exponentially with a time-constant proportional to the thermal capacitance of the materials in the greybody zone 206 and the resistance to the flow of radiation produced by incandescence in the greybody materials provided by the mirrored spherical enclosure 202.

In steady-state operation, the effective average temperature of the HNG and the graphene aerogels is roughly 5000 K and so the greybody zone emits electromagnetic radiation that has a spectral radiance distribution curve similar to that of the sun. The greybody zone 206 thus acts as a steady source of electromagnetic energy to heat the pressurized water 212. The temperature and flowrate of the high pressure water pumped around the spherical enclosure cools the mirrored enclosure 202 by an amount sufficient to maintain the enclosure below its melting point. A graphene coating 215 may be infused in the mirrored spherical enclosure 202 to strengthen it.

Insofar as fuel reaction zone 208 is concerned, it is well-established that heat can be generated in a conductor (derived from Faraday's law of electromagnetic (EM) induction as amplified by Lenz's law). In a situation in which there is a rapidly changing magnetic flux, the fuel gas becomes a highly conducting plasma (this is aided by the prior insertion of Po-210, as described previously). Eddy currents produced in the plasma can efficiently couple EM energy into the fuel plasma, causing rapid heating of the fuel. For example, coaxial electrically conducting coils (not shown in the figures) could be energized by a high frequency alternating electric current, causing rapid changes in the magnetic flux in the gas. By Lenz's law, the gas medium, if highly ionized and thus a conducting plasma, creates a magnetic field opposing the change in magnetic flux produced by the coils via the cylindrical flow of current in the plasma rotating in an opposite direction to the flow of current in the coils. However, this approach may have significant drawbacks associated with the functioning of the greybody and the mirrored spherical enclosure proposed. Advantageously, the same heating effect can instead be created by rapidly rotating high intensity permanent magnets aligned axially on opposite sides of the reaction zone and mounted outside the fusion sphere, as described herein.

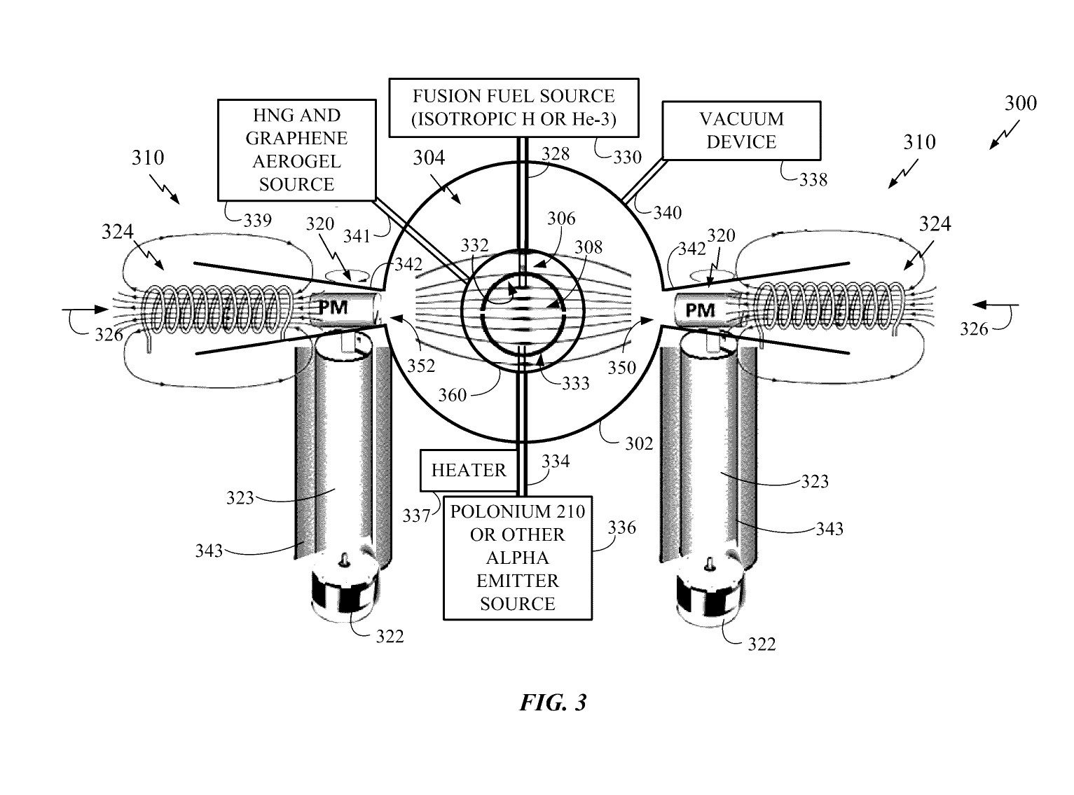

FIG. 3 illustrates an exemplary implementation of a spherical fusion machine 300, particularly illustrating components of a pair of magnetic field generators 310 mounted external to a mirrored spherical enclosure or shell 302. Each magnetic field generator 310 includes a permanent magnet 320 configured to spin at high speed by an electrical motor drive 322. The permanent magnet is integrated with a large moment of inertia cylinder to form a rotating permanent magnet assembly 323 that can be brought up to speed slowly such that, when the permanent magnet apparatus reaches maximum operational speed, the angular momentum and rotational kinetic energy of the apparatus is sufficiently large that the rotational speed of the apparatus is then maintained with a relatively small “continuous” power input. Alternatively, after reaching maximum operational speed the power to the rotating assembly can be shut down until the minimum acceptable operational speed is reached. The rotational inertia of the assembly is sufficient to maintain the rotational speed of the magnets at a level adequate for acceptable performance of the machine over a substantially large period of time. This may exploit minor input power to maintain synchronization of the magnets.

The rotating magnet assembly is housed inside a casing 343 which is sealed and evacuated to reduce “windage” losses in the rotating magnet assembly. (In this regard, the rotating magnet assembly includes the magnets and the high rotational inertia cylinders. The two are “attached” to one another. Outside the rotating magnet assembly is a “casing” that is be evacuated to reduce the windage losses caused by the motion of the assembly through air.) The casing is be designed to contain the kinetic energy of the rotating magnet assembly in the unlikely event that the rotating assembly becomes unstable. It may be made of a non-metallic, non-magnetic material. In order to avoid de-magnetization of the permanent magnets due to heating, it may be advisable to cool the permanent magnets via radiative cooling by circulating cooled liquid through an upper chamber of the casing near the permanent magnets.

Fuel within the fuel reaction zone 308 is heated by the magnetic effects of the motion of the magnets and constrained to the reaction zone by a pair of larger superconducting magnets 324, which create a steady magnetic field along an axis 326 through the center of the spherical fuel reaction zone. Insofar as the initiation of the fusion process is concerned, the initial operating pressure of the fusion sphere (i.e. everything within mirrored enclosure 302) can be supra-atmospheric or sub-atmospheric but preferably is near one atmosphere. Development testing of a particular embodiment of the reactor may show that pressure relief valves (not shown in FIG. 3) may be advisable to mitigate machine over-pressure, particularly during initial excitation of fusion reactions. If appropriate, they may be located in the outer mirrored surface 302 and may be connected to conduit 340. The greybody portion of the sphere (i.e. greybody zone 306) is partially or completely filled with aerogel structures, as already explained. These can comprise, for example, many individual structures of spherical or cylindrical shape (with spherical preferred), with the precise shape depending on any limitations or constraints of the aerogel manufacturing processes. At the center of the fusion sphere, in the fuel reaction zone 308, there is an open volume or space into which the fuel for nuclear fusion is introduced by, e.g., long telescoping ceramic tube(s) 328 that extend radially toward the center from a fusion fuel source 330 mounted beyond the perimeter of the sphere 302.

Two nets made of high temperature materials (possibly carbon-based material coated with a few layers of graphene) 332 and 333 may be located in the fuel reaction zone near its outer perimeter. In the example of FIG. 3, one of the graphene nets 332 encloses the fuel reaction zone 308 just inside its outer perimeter and the other 333 is located at the outer perimeter of 308. The nets 332 and 333 should be fundamentally spherically shaped and attached under radial tension to an inside surface of the spherical enclosure 302 via strands of material similar to the net material. Nets 332 and 333 are substantially concentric to one another. High-density graphene aerogel structures saturated with fuel are introduced into the region between the two nets 332 and 333 via tubes 328 from fusion fuel source 330. These fuel-adsorbing graphene aerogel structures may be considerably denser than the HNG graphene aerogel structure to maintain near-neutral buoyancy between the two types of aerogels and provide significant resistance to the flow of fuel and HNG between the fuel reaction zone 308 and the greybody zone 306. The mesh density of the nets is just sufficient to segregate the fuel-adsorbing graphene aerogels in the fuel reaction zone 308 from the HNG-adsorbing aerogels in the greybody zone 306. The graphene-coated net(s) 332, 333 may also be arranged and configured to accommodate the telescoping ceramic tube(s) 328, which introduce the fuel to the center, e.g., long telescoping ceramic tube(s) 328 that extend radially toward the center from a fusion fuel source 330 mounted beyond the perimeter of the sphere 302.

Unless constrained the aerogels filled with HNG will tend to fall to the bottom of the sphere 302. To constrain the volume of the graphene aerogel structures to the greybody zone 306, they may be contained within a fundamentally spherically shaped graphene-coated net(s) 360 positioned at the perimeter of the greybody zone, roughly concentric to the nets 332 and 333. The nets 360 should be fundamentally spherically shaped and attached under radial tension to an inside surface of the spherical enclosure 302 via strands of material similar to the net material. The various nets 332,333, and 360 may be tethered to an inside surface of the spherical enclosure 302 (via one or more tethers not shown in FIG. 3) to properly locate the net(s). Depending upon the particular graphene aerogels for use in the greybody zone (and their reaction to the high heat of the fusion reactions), it may be advisable to employ additional nets to constrain the graphene aerogels so that the greybody zone 306 remains substantially in the same position. The mesh density of the nets is just sufficient to segregate the fuel-adsorbing graphene aerogels in the fuel reaction zone from the HNG-adsorbing aerogels in the greybody zone. The graphene-coated net(s) 332, 333 and 360 may also be arranged and configured to accommodate the telescoping ceramic tube(s) 328, which introduce the fuel to the center, and one or more other telescoping ceramic tubes or structures 334 (also extending from the perimeter of the fusion sphere), which provide a small amount of Po-210 or another alpha-emitter from an alpha emitter source 336. The telescoping ceramic tubes or structure 341 which introduce graphene aerogels infused with HNG from the HNG and graphene aerogel source 339 are similarly accommodated.

Additionally, a beta particle emitter (such as Xe-135) as a component of the HNG may be delivered to the greybody zone and the inhibited heat conduction and convection zone via HNG and graphene aerogel source 339 and a suitable delivery conduit 341. The beta particles (electrons) from the Xe-135 atoms located in the greybody zone have sufficient range to produce ions and electrons in the fuel gas in the fuel reaction zone, thereby “pre-ionizing” the fuel and producing an electrically conducting state in the fuel. A more uniform electric discharge is then more readily established by the changing magnetic flux within the fuel reaction zone, leading to more uniform distribution of the electrical energy input by the dynamic magnetic field and enable efficient operation at higher operating pressures. Xe-135 is also an excellent absorber of low-energy (thermal) neutrons with an extraordinarily large cross section of about 2.5 million barns at these energies. High-energy neutrons are produced in most fusion reactions. The materials in the greybody zone 306 and the inhibited heat conduction/heat convection zone 304 slow neutrons substantially but perhaps not completely. The Xe-135 may absorb lower energy neutrons around the outer perimeter of the sphere in the inhibited heat conduction/heat convection zone 304, providing some reduction in neutron activation of the structures on the outer perimeter of the machine 302.

The high-pressure water circulating around the sphere completely or substantially absorbs any additional electromagnetic radiation produced by the neutron activation of the outer structures of the machine. Further, an alpha emitter (such as Po-210) may be provided via “polonium 210 or other alpha emitter” source 336 and a suitable delivery conduit 334. It can be positioned to create a highly conducting plasma at the center of the fuel reaction zone 308. This plasma is confined to the center of the sphere by an intense static magnetic field prior to energy input to the fuel gas to localize the energy flow from the changing magnetic flux. It can then transfer its heat/kinetic energy over to the fuel gas that is collocated at the center, creating a partially ionized plasma in the fuel gas in a relatively small volume of the fuel reaction zone, acting as a “trigger” for the onset of the fusion reactions. The beta emitter and the alpha emitter chosen act to enhance the operating envelope of the machine, extending it to significantly higher pressures than otherwise attainable. The alpha emitter can act as a “trigger” to initiate the formation of the fuel plasma largely throughout the fuel reaction zone at the onset of achievement of operational speed by the rotating magnets. Thus an isotope of xenon, Xe-135, may be advantageously used in the fusion machine. It decays to Cs 135, which is very stable or, in a situation in which there is a high thermal neutron flux, it absorbs the neutrons and becomes Xe-136, which is essentially stable, having a half-life of 2×10²¹ years. Further, an isotope of polonium, Po-210 may be advantageous as well. It decays to Pb-206, which is stable. As discussed in more detail below, the graphene aerogel may be saturated with HNG, including the Xe-135 component, in the HNG and graphene aerogel source 339 and delivered by tube 341. After the initial injection of the Po-210 into the fuel reaction zone (described immediately below), Po-210 is resupplied on an as-needed basis via very small graphene aerogel structures infused with the Po-210 and fuel gas in source 336 and delivered via conduit 334. These aerogel bodies are designed to have near-neutral buoyancy in the fuel zone. After the plasma state has been established at the center of the sphere, the various telescoping deliver tube(s) 328, 334 and 341 are retracted to the outer perimeter of the sphere (using retraction controller devices not shown in FIG. 3).

The fusion sphere is initially filled with air (at atmospheric pressure). The graphene aerogels (which are substantially deformable) and “transparent” aerogels may be saturated with HNG at slightly above atmospheric pressure and introduced from source 339 via a suitable delivery conduit 341 at the top of the machine and displace the air in the sphere with HNG, which is, of course heavier than air. The air would rise to the top of the machine and be evacuated by a vacuum device 338 via a suitable tube or connector 340. The aerogels may be positioned in the greybody zone and the inhibited heat conduction/heat convection zones with, if necessary, special robotic machinery (not shown in FIG. 3). The graphene aerogels are introduced first and the transparent aerogels introduced last to properly position them. It may be advisable to use special robotics and video equipment to ensure that they are properly positioned in the “zones” where they “belong” (graphene aerogel in zone 306 and transparent aerogels (if used) in zone 304) within the graphene-coated assembly of nets. To initially locate and insert the fuel a deformable balloon or a “balloon-like” membrane is positioned inside the fuel zone and pressurized with fuel gas from source 330 via conduit 328 to displace the HNG from the fuel reaction zone 308. (Note that there may be some HNG in the fuel reaction zone because the HNG is not perfectly absorbed by the aerogels.) Methods have been developed to make deformable balloons so that the balloon could accurately “fit” to the exact optimal dimensions of the fuel zone. The membrane, if used, would slowly diffuse the fuel into the fuel zone.

To initially introduce the Po-210 reaction igniter, one or more graphene aerogels structures may be infused with the Po-210. These could be small structures that can be deformed when constrained and retain their original shape when unconstrained. They can be inserted in the “balloon” discussed in the previous paragraph and centered prior to inflation or inserted in an “inner-balloon” that is also deformable and ensures that the Po-210 is properly positioned. When the rotating magnets are at operational speed, the balloon(s) are then rapidly pressurized with fuel from 330 via conduit 328 and heating of the fuel ensues. Additionally, for the rotating electro-magnet approach, the switch connecting the current generator to the magnet coils is then be closed so that current flows in the magnetic coils at that time. During the process of heating, the balloon with aerogel materials is vaporized or significantly altered and then vacates the fuel heating zone. During steady operation, fuel would be added from the fusion fuel source (330) via conduit 328 into the lower section of the fuel reaction zone. The graphene aerogels located directly above the fuel reaction zone are preferably designed to be particularly restrictive to fuel flow and receptive to fuel adsorption. Some fuel may escape the fuel reaction zone without undergoing fusion and migrate to the top of the machine. Some of the gas at the top of the sphere can be “syphoned off” by creating a partial vacuum in small container(s) above the machine (not shown in FIG. 3). The gas would contain some HNG (which is also valuable). Because of their large mass difference, the fuel gases and HNG can easily be separated in a centrifuge machine to re-supply the fuel for the reaction zone and HNG for the other zones. After the initial injection of the Po-210 into the fuel reaction zone, it is resupplied on an as-needed basis via very small graphene aerogel structures infused with the Po-210 and fuel gas. These bodies are designed to have near-neutral buoyancy in the fuel zone. They are injected from source 336 via conduit 334 into the center of the fuel reaction zone.

As electromagnetic energy is fed from the rotating permanent magnets 320 into the fuel plasma (with convection and radiation of heat greatly inhibited by the HNG-infused aerogel structures), the fuel is thereby energized on each turn of the rotating magnets 320. The relative velocity of some of the fuel gases (in ionized states) is sufficient to initiate the fusion process in the fuel reaction zone 308. With the onset of the fusion process, the steady magnetic field will continue to form a magnetic bottle that continues to constrain the high energy charged particles produced to the fuel reaction zone 308, perhaps further “igniting” fusion reactions.

The delivery of energy into the fuel and the confinement of the fuel to the fuel reaction zone 308 are accomplished by combining the effects of the high intensity magnetic field (generated by superconducting magnets 324) coupled with the rotating high intensity permanent magnets 320. The rotating magnets 320 rotate in the same direction as one another at extremely high rotational speeds. As the rotational speed of the magnets increases, the rate of change of the magnetic flux increases. To keep the permanent magnets 320 from deforming at high rotational speed, it may be advantageous to coat layers of graphene around the perimeter of the permanent magnets (not shown in FIG. 3). The enormous tensile strength of graphene allows the high magnet rotational speed employed to maximize the power delivered to the fuel reaction zone.

When the magnetic field produced by the stationary magnets 324 is aligned with the magnetic fields produced by the permanent magnets 320, the magnetic field inside the fusion sphere is at (or near) its maximum value. When the permanent magnets 320 are rotated 90° from one another, the magnetic field is approximately that of the superconducting magnets 324 alone. When the permanent magnets 320 rotate to a position 180° from the position shown in FIG. 3, the cumulative magnetic field inside the fuel reaction zone 308 is at (or near) its minimum value. As the axes of the rotating permanent magnets 320 come into and out of alignment, rapid changes in the magnetic flux occur, driving the eddy currents in the fuel plasma to a maximum and producing high peak power and “heating” in the plasma contained within the fuel reaction zone 308.

As an alternative to the arrangement of FIG. 3, highly conducting, high temperature conducting graphene-infused materials may be employed to facilitate the generation of time-changing magnetic fields derived from high-frequency alternating currents by passing those currents through a set of coils placed inside the core of the fusion sphere. This alternative arrangement (not shown) has the advantage of placing the source of the dynamic field in closer proximity to the fuel reaction zone. However, the coils would be in the intense heat and electromagnetic flux of the fusion plasma, limiting their life and the high frequency electromagnetic radiation produced would radiatively heat the greybody zone 306 and the mirrored spherical enclosure of the sphere 302, diverting much of its energy away from the fuel reactor zone 308 where its energy is most efficaciously used.

Although the permanent magnets provide one means for generating the dynamic magnetic fields, the same functionality can be provided by an electro-magnet wound around (for example) a high tensile strength core coated with layers of graphene. (It is noted that, depending upon the rotational speeds appropriate for a particular reactor design, certain rotating permanent magnets might not have sufficient tensile strength and so, in such embodiments, an electro-magnet is preferred.) The core material must be non-magnetic and, preferably non-conducting. Electrical connections somewhat similar to the “brushes” used in DC motors would have to slide around two circular or elliptical metal rings (one for the +connection and one for the −connection of the electro-magnet coil) attached to the casing and connected to a high current DC power supply to provide the current for the electromagnet. The DC power supply could be a “homopolar generator” which provides very high currents at relatively low voltages, ideal for electromagnets.

As noted previously, the magnetic field formed by the superconducting magnets produces a magnetic bottle, which tends to constrain the plasma fuel particles to the center of the fusion sphere. As with all magnetic bottle and magnetic mirror machines, a relatively small number of ionized particles produced fusion reactions may escape along the axis 326 of the magnetic field. The energy of these particles can be converted to heat in the greybody zone via multiple collisions with HNG located there. Magnetic “hoses” 342 are used to couple the superconducting and rotating magnetic fields and guide the magnetic field into the fusion sphere via a non-magnetic dielectric windows 350 and 352. Note that the hoses do not penetrate the interior of the machine. Rather, they are close-coupled to one of the magnetic windows. (The dielectric windows 350 and 352 are located along the magnetic field/fusion reaction zone axis. These are openings—two openings oppositely opposed on either side—of the structural enclosure and the mirrored enclosure 302 to allow the magnetic fields to penetrate into the central heating zone. Without these windows, the aluminum mirror would intercept the changing magnetic flux produced by the rotating magnets and heat the mirror rather than the fusion fuel.) In one example, the magnetic hoses 342 include alternating concentric cylinders of a high-permeability material (e.g. a ferromagnet) and a low-permeability material (e.g. a superconductor). Roughly speaking, when a source field is placed at one end of the cylinder, the ferromagnetic shells of the hoses 342 magnetize and regenerate the source field along the length of the cylinder, while the superconducting shells of the hoses serve to keep the field lines from spreading outward. Of course, openings in the mirrored spherical surface and the outer structure of the machine allow the dynamic magnetic field to penetrate into the machine. The graphene aerogel materials are designed to have very low electrical conductivity so no significant eddy currents are produced in the aerogel structures.

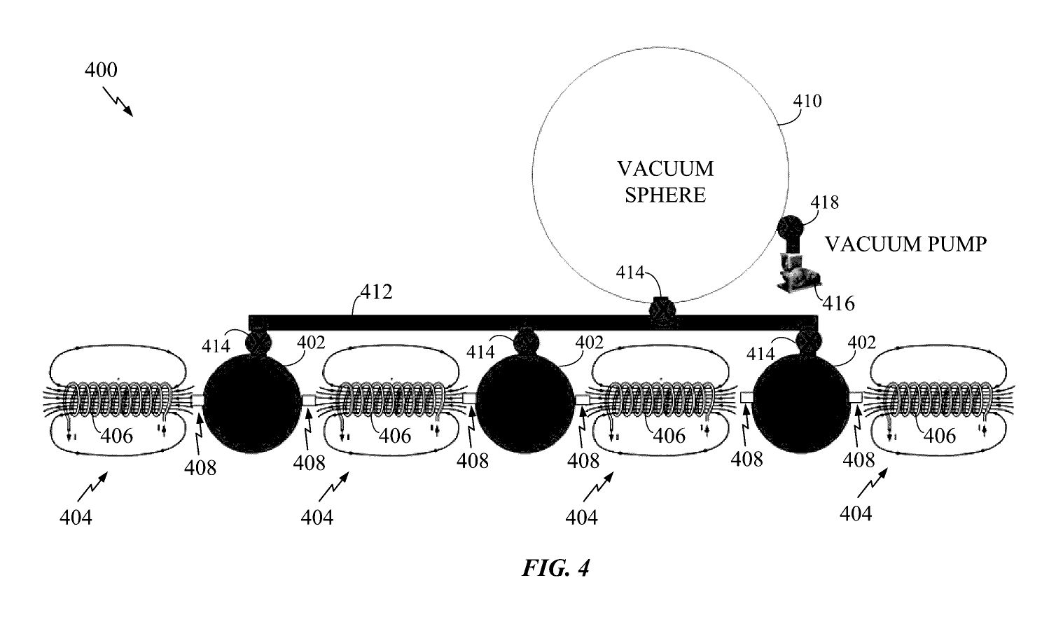

FIG. 4 illustrates a nuclear fusion reactor power plant or system 400 having a set of individual spherical fusion machines or apparatus 402 mounted in a linear array with a magnetic field generator 404 installed between each pair of adjacent machines. (In FIG. 4, only the superconducting magnets 406 and magnetic hoses 408 of the magnetic field generators are shown. Other components of the magnetic field generators, such as the rotating permanent magnetics are not shown in FIG. 4. Still other components of the fusion machines, such as telescoping tubes for delivery of fusion fuel, are also not shown. See, FIG. 3.) With a linear arrangement of fusion machines, individual magnetic field generators 404 can provide magnetic fields for use with two adjacent fusion machines 402, thereby to reduce the number of components needed. FIG. 4 also illustrates a vacuum sphere 410 for evacuating gasses or materials from within the individual fusion machines 402 via one or more conduits 412 using a set of valves 414. A vacuum pump 416, connected to vacuum sphere 410 via a valve 418, is used to generate a vacuum within the vacuum sphere.

In a power plant containing multiple fusion machines, the number of superconducting magnets can be thus reduced by aligning the machines as shown in FIG. 4. The fusion spheres are manifolded to the large evacuated sphere 410, as shown, to quickly evacuate the contents of the fusion spheres, if appropriate. This may include removal of spent graphene aerogel assemblies, as well as the gases and vaporized polonium. Feed units (shown in FIG. 3) are used to supply the fusion fuel and the HNG. Fusion and manifold surfaces may benefit from auxiliary heating via one or more auxiliary heater(s) 337 to inhibit solidification of Po. The melting point of Po is relatively low at 527 K. The melting point of aluminum is 933 K, so the auxiliary heaters help keep the Po from solidifying on internal surfaces of the fusion machine.

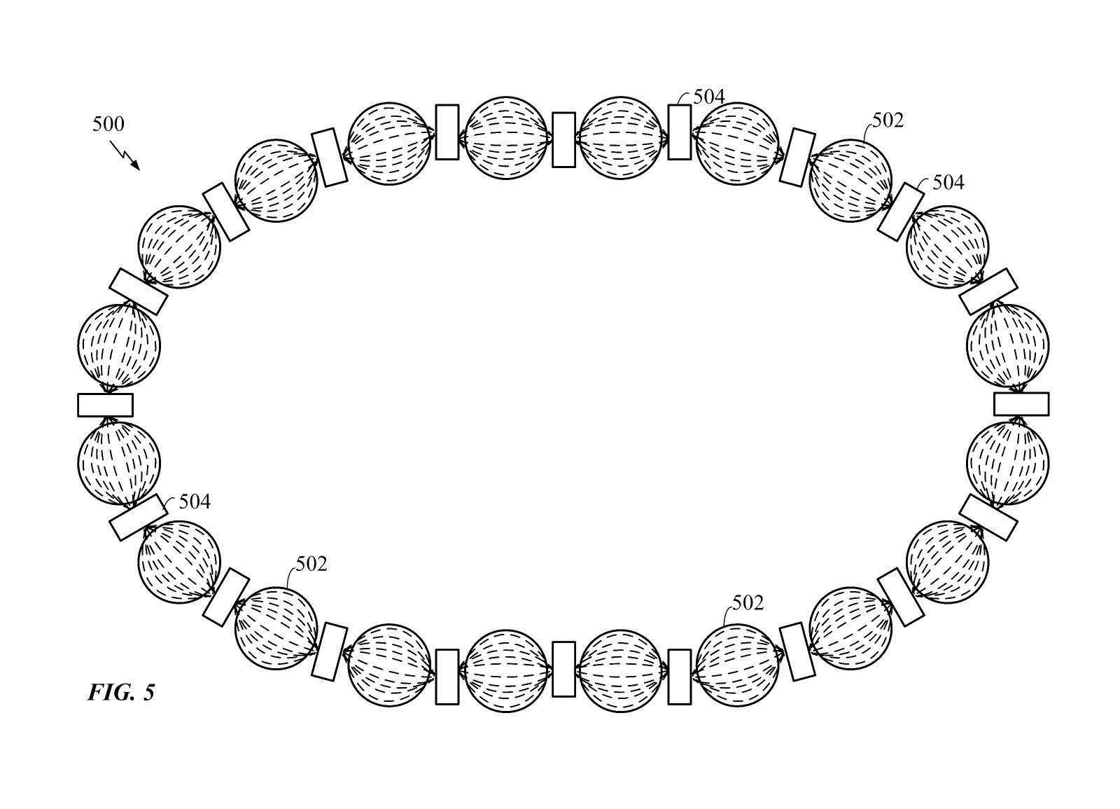

FIG. 5 illustrates another power plant/system 500 having a set of twenty spherical fusion machines 502. In this example, the fusion machines are arranged in an elliptical loop with a magnetic field generator 504 installed between each individual machine 502. A circular loop may instead be employed. In the particular example of FIG. 5, the fusion machines are arranged in a loop with magnetic field generators 504 of the type described above (and shown in FIG. 3) positioned between fusion machines that are fundamentally aligned along the radius of curvature of the loop. As can be appreciated, the radius of the loop (i.e. the radius of the circle or the major axis of the ellipse), and ultimately, the size of the array will depend on the angle with which the magnets (particularly the larger superconducting magnet) can be arranged and still maintain effective functioning of the magnetic bottle. With a loop arrangement of fusion machines, individual magnetic field generators can provide magnetic fields for use with adjacent fusion machines to further reduce the number of components needed. (Note that the stylized illustration of FIG. 5 does not show all components that might be employed, such as magnetic hoses, telescoping tubes for delivery of fusion fuel, vacuum systems, etc.)

### Summary of Exemplary Operational and Design Procedures

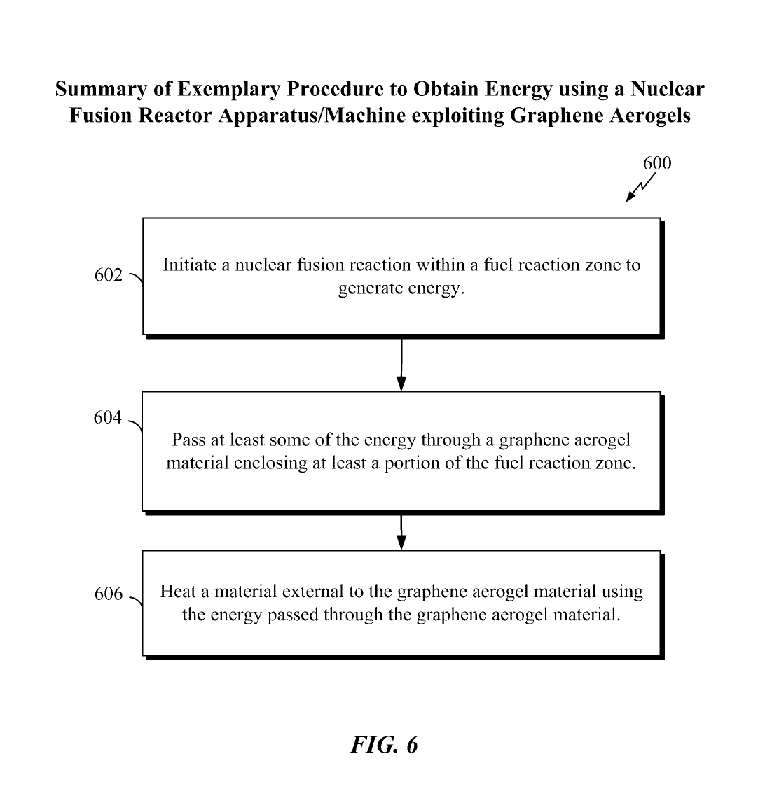

FIG. 6 broadly summarizes a procedure 600 for obtaining energy from nuclear fusion using a nuclear fusion reactor apparatus or machine such as the one shown in FIGS. 1-5 or other suitably-equipped devices. Briefly, at 602, a nuclear fusion reaction is initiated within the fuel reaction zone of the nuclear fusion reactor apparatus to generate energy. At 604, at least some of the energy is passed through a graphene aerogel material enclosing at least a portion of the fuel reaction zone. At 606, a heat-transferring fluid (such as pressurized water) external to the graphene aerogel material is heated using the energy passed through the graphene aerogel material. As already explained, the heated pressurized water (or other suitable fluid) can then be used to transfer heat to a conventional steam-cycle apparatus to spin a turbine and generate electrical power.

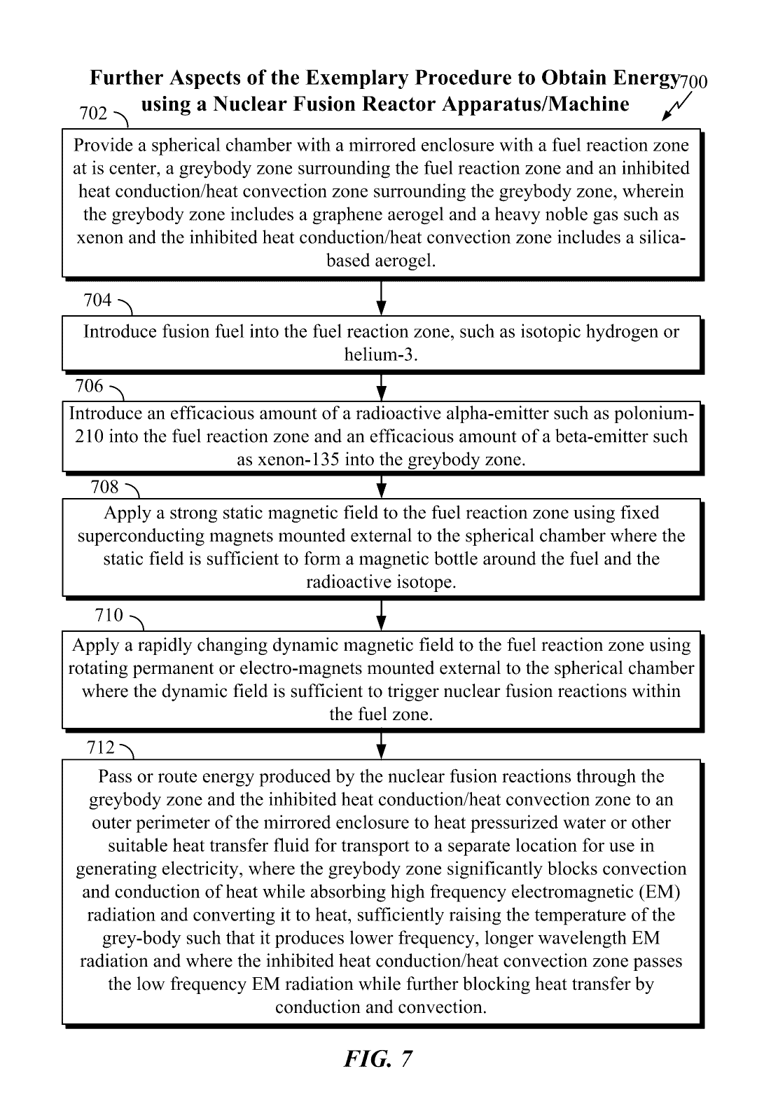

FIG. 7 illustrates and summarizes further aspects of an exemplary procedure 700 for obtaining energy from nuclear fusion. At 702, a spherical chamber with a mirrored enclosure is provided that has a fuel reaction zone at its center, a greybody zone surrounding the fuel reaction zone and an inhibited heat conduction/heat convection zone surrounding the greybody zone, wherein the greybody zone includes graphene aerogels and an HNG such as xenon and where the inhibited heat conduction/heat convection zone includes transparent aerogels (e.g. silica or silica/graphene). At 704, fusion fuel, such as isotopes of hydrogen or He-3 is introduced into the fuel reaction zone, and, at 706, an efficacious amount of an alpha-emitting radioactive isotope, such as polonium-210, is introduced into the fuel reaction zone. At 708, a strong static magnetic field is applied to the fuel reaction zone using fixed superconducting magnets mounted external to the spherical chamber where the static field is sufficient to form a magnetic “bottle” around the fuel and the radioactive isotope. At 710, a rapidly changing dynamic magnetic field is applied to the fuel reaction zone using rotating permanent or electro-magnets mounted external to the spherical chamber, where the dynamic field is sufficient to trigger a nuclear fusion reaction within the fuel reaction zone. At 712, energy produced by the nuclear fusion reaction is passed through or otherwise routed through the greybody zone and the inhibited heat conduction/heat convection zone to an outer perimeter of the mirrored enclosure to heat pressurized water or other suitable heat transfer fluid for use in generating electricity, where the greybody zone significantly blocks convection and conduction of heat while absorbing high frequency electromagnetic (EM) radiation and converting it to heat, sufficiently raising the temperature of the grey-body such that it incandescently produces lower frequency, longer wavelength EM radiation and where the inhibited heat conduction/heat convection zone passes the low frequency EM radiation while further blocking heat transfer by conduction and convection.

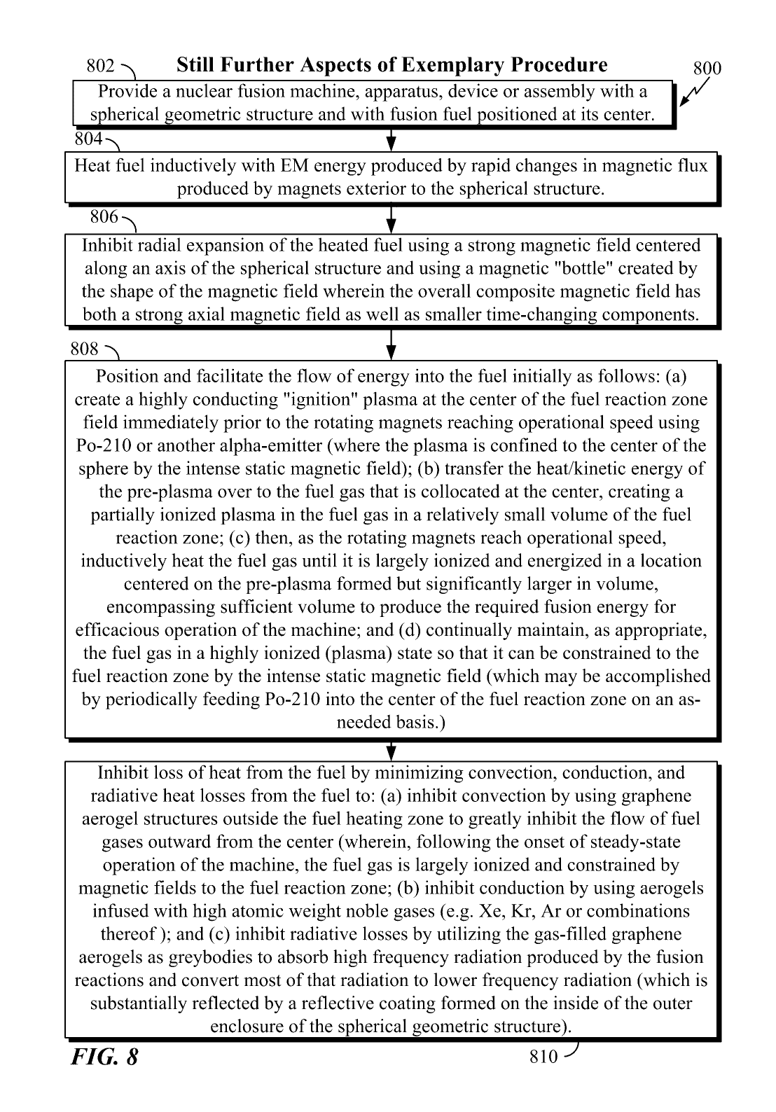

FIG. 8 illustrates and summarizes still further aspects of an exemplary procedure 800 for obtaining energy from nuclear fusion. At 802, a nuclear fusion machine, device, apparatus or apparatus is provided with a spherical geometric structure and with fusion fuel positioned at its center. At 804, fuel is heated inductively with EM energy produced by rapid changes in magnetic flux produced by magnets exterior to the spherical structure. At 806, radial expansion of the ionized heated fuel is inhibited using a strong magnetic field along an axis of the spherical structure and using a magnetic “bottle” created by the shape of the magnetic field wherein the overall composite magnetic field has both a strong axial magnetic field as well as smaller time-changing components. At 808, the flow of energy into the fuel is initially positioned and facilitated as follows: (a) create a highly conducting “ignition” plasma at the center of the fuel reaction zone field immediately prior to the rotating magnets reaching operational speed using Po-210 or another alpha-emitter. This plasma is confined to the center of the sphere by the intense static magnetic field; (b) transfer the heat/kinetic energy of the pre-plasma over to the fuel gas that is collocated at the center, creating a partially ionized plasma in the fuel gas in a relatively small volume of the fuel reaction zone; and (c) then, as the rotating magnets reach operational speed, inductively heat the fuel gas until it is largely ionized and energized in a location centered on the pre-plasma formed but significantly larger in volume, encompassing sufficient volume to produce the appropriate fusion energy for efficacious operation of the machine; and (d) continually maintain, as appropriate, the fuel gas in a highly ionized (plasma) state so that it can be constrained to the fuel reaction zone by the intense static magnetic field. This may be accomplished by periodically feeding Po-210 into the center of the fuel reaction zone on an as-needed basis.

At 810, loss of heat from the fuel is inhibited by minimizing convection, conduction, and radiative heat losses from the fuel to: (a) inhibit convection by using graphene aerogel structures outside the fuel heating zone to greatly inhibit the flow of fuel gases outward from the center. Additionally following the onset of steady-state operation of the machine, the fuel gas will be largely ionized and constrained by magnetic fields to the fuel reaction zone (b) inhibit conduction by using aerogels infused with high atomic weight noble gases (e.g. Xe, Kr, Ar or combinations thereof); and (c) inhibit radiative losses by utilizing the gas-filled graphene aerogels as greybodies to absorb high frequency radiation produced by the fusion reactions and convert most of that radiation to lower frequency radiation (which is substantially reflected by a reflective coating formed on the inside of the outer enclosure of the spherical geometric structure). In other words, the high frequency (mainly x-ray radiation) E-M radiation produced in the fusion reaction is largely captured and heats the greybody region to a high enough temperature (about 5000 K) such that the EM spectral emission is analogous to that of the sun. Radiative resistance to the flow of heat from the greybody, produced by the reflective coating, causes the greybody to cool more slowly than it would otherwise and the greybody temperature is maintained at a relatively high level.

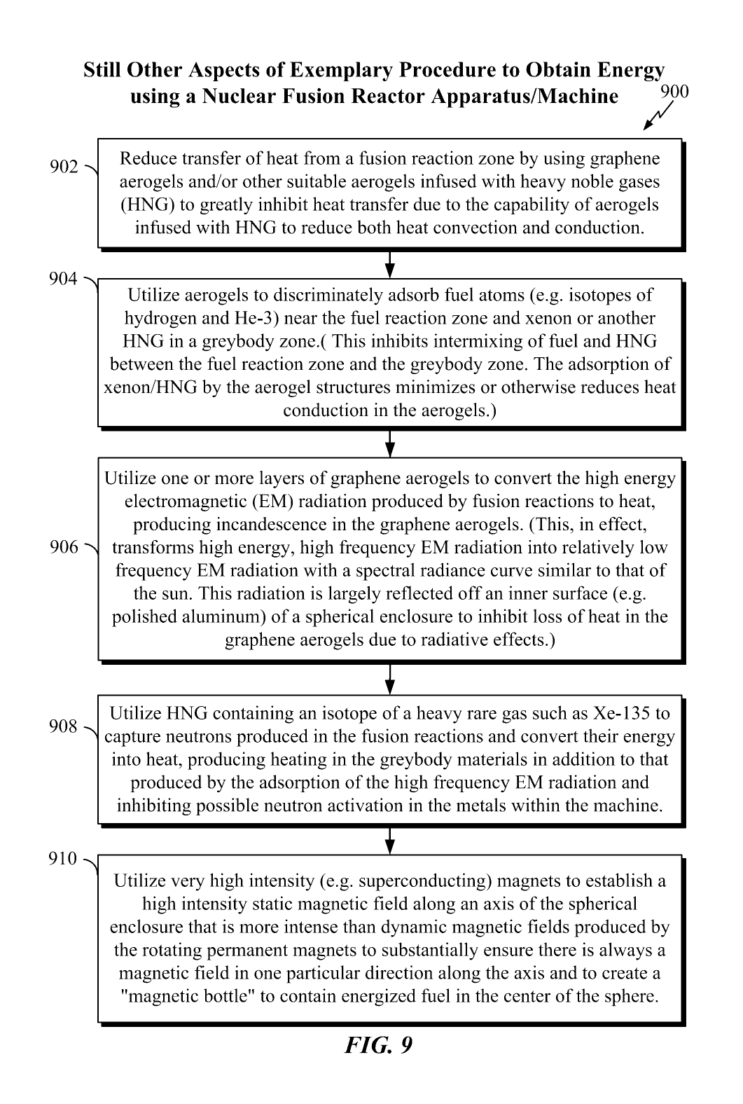

FIG. 9 illustrates and summarizes still other aspects of an exemplary procedure 900 for obtaining energy from nuclear fusion. At 902, transfer of heat from a fusion reaction zone is reduced by using graphene aerogels and/or other suitable aerogels infused with heavy noble gases HNG to greatly inhibit heat transfer due to the capability of aerogels infused with HNG to reduce both heat convection and conduction. At 904, aerogels are utilized to discriminately adsorb fuel atoms (e.g. isotopes of hydrogen and He-3) near the fuel reaction zone and xenon or other HNGs in a greybody zone. This inhibits intermixing of fuel and HNG between the fuel reaction zone and the greybody zone. The adsorption of xenon/HNG by the aerogel structures minimizes or otherwise greatly reduces heat conduction in the aerogels. At 906, one or more layers of graphene aerogels are utilized to convert the high energy electromagnetic (EM) radiation produced by fusion reactions to heat, producing incandescence in the graphene aerogels. This, in effect, transforms high energy, high frequency EM radiation into relatively low frequency EM radiation with a spectral radiance curve similar to that of the sun. This radiation is largely reflected off an inner surface (e.g. comprising polished aluminum) of a spherical enclosure to inhibit loss of heat in the materials in the greybody zone due to radiative effects. At 908, HNG containing an isotope of a heavy rare gas such as Xe-135 is utilized to capture neutrons produced in the fusion reactions and convert their energy into heat, producing heating in addition to that produced by the adsorption of the high frequency EM radiation discussed above, and inhibiting possible neutron activation in the metals within the machine. At 910, very high intensity (e.g. superconducting) magnets are utilized to establish a high intensity static magnetic field along an axis of the spherical enclosure that is more intense than dynamic magnetic fields produced by the rotating permanent magnets or electro-magnets to substantially ensure there is always a magnetic field in one particular direction along the axis and to create a “magnetic bottle” to contain energized fuel plasma in the center of the sphere.

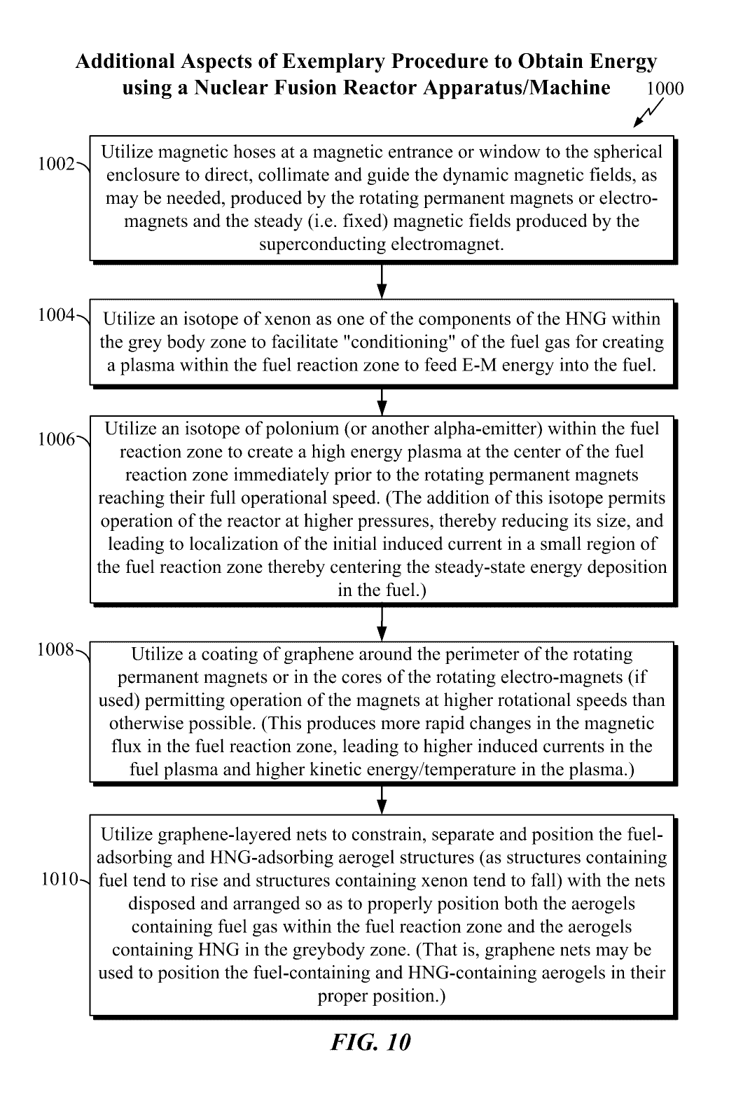

FIG. 10 illustrates and summarizes still other aspects of an exemplary procedure 1000 for obtaining energy from nuclear fusion. At 1002, magnetic hoses are utilized at a magnetic entrance or window to the spherical enclosure to direct, collimate and guide the dynamic magnetic fields, as may be needed, produced by the rotating permanent magnets or electro-magnets and the steady (i.e. fixed) magnetic fields produced by the superconducting electromagnet. At 1004, an isotope of xenon is utilized as one of the components of the HNG within the grey body zone to facilitate “conditioning” of the fuel gas for creating a plasma within the fuel reaction zone to feed E-M energy into the fuel. At 1006, an isotope of polonium (or another alpha-emitter) is utilized within the fuel reaction zone to create a high energy plasma at the center of the fuel reaction zone immediately prior to the rotating permanent magnets reaching their full operational speed. The addition of this isotope permits operation of the reactor at higher pressures than would otherwise occur, reducing its size, and leads to localization of the initial induced current in a small region of the fuel reaction zone thereby centering the steady-state energy deposition in the fuel. At 1008, a coating of graphene around the perimeter of the rotating permanent magnets or in the cores of the rotating electro-magnets (if used) permits operation of the magnets at higher rotational speeds than otherwise possible. This produces more rapid changes in the magnetic flux in the fuel reaction zone, leading to higher induced currents in the fuel plasma and higher kinetic energy/temperature in the plasma. At 1010, graphene-layered nets are utilized to constrain, separate and position the fuel-adsorbing and HNG-adsorbing aerogel structures (as structures containing fuel tend to rise and structures containing xenon tend to fall) with the nets disposed and arranged so as to properly position both the aerogels containing fuel gas near the fuel reaction zone and the aerogels containing HNG in the greybody zone. (That is, graphene nets may be used to position the fuel-containing and HNG-containing aerogels in their proper position.)

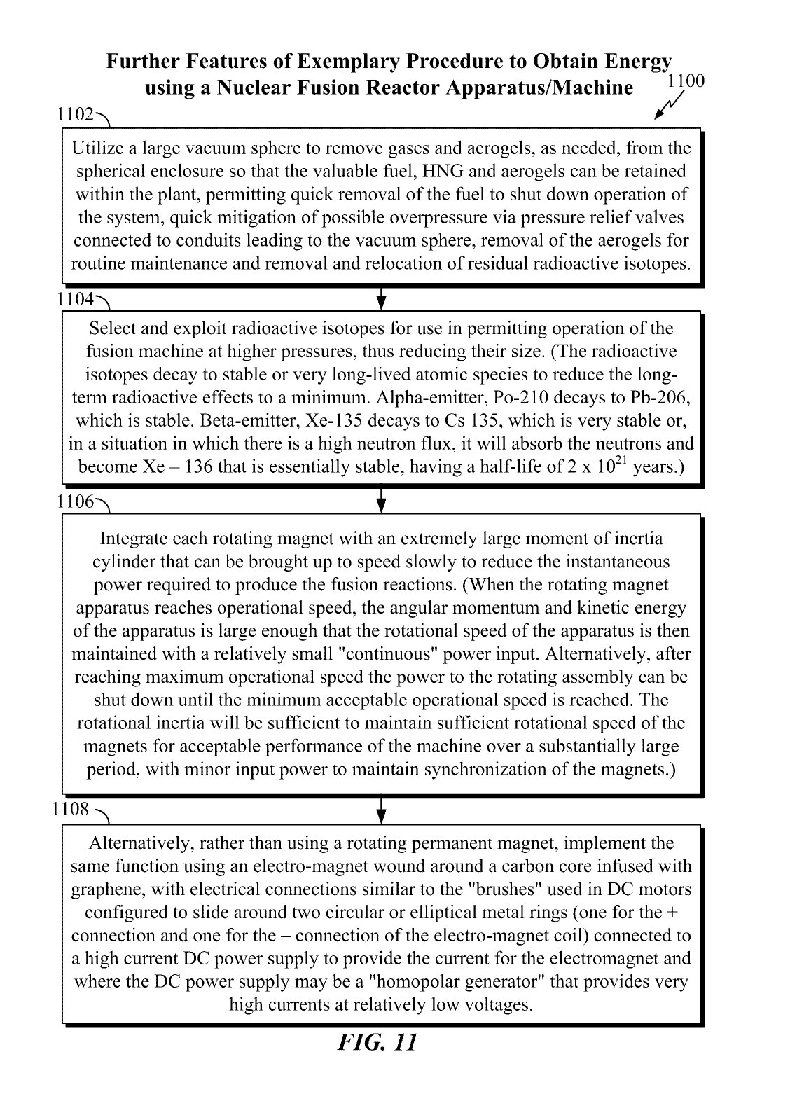

FIG. 11 illustrates and summarizes still other aspects of an exemplary procedure 1100 for obtaining energy from nuclear fusion. At 1102, a large vacuum sphere is utilized to remove gases and aerogels, as needed, from the spherical enclosure so that the valuable fuel, HNG and aerogels can be retained within the plant, permitting quick removal of the fuel to shut down operation of the system, quick mitigation of possible overpressure via pressure relief valves connected to conduits leading to the vacuum sphere, removal of the aerogels for routine maintenance and removal and relocation of residual radioactive isotopes. At 1004, radioactive isotopes are selected and exploited for use in permitting operation of the fusion machine at higher pressures, thus reducing their size. The radioactive isotopes decay to stable or very long-lived atomic species to reduce the long-term radioactive effects to a minimum. An alpha-emitter, Po-210 decays to Pb-206, which is stable. A beta-emitter, Xe-135 decays to Cs 135, which is very stable or, in a situation in which there is a high neutron flux, it absorbs the neutrons and become Xe-136 that is essentially stable, having a half-life of 2×10²¹ years. At 1106, each rotating magnet is integrated with an extremely large moment of inertia cylinder that can be brought up to speed slowly to reduce the instantaneous power used to produce the fusion reactions. When the rotating magnet apparatus reaches operational speed, the angular momentum and rotational kinetic energy of the apparatus is large enough that the rotational speed of the apparatus is then maintained with a relatively small “continuous” power input. Alternatively, after reaching maximum operational speed the power to the rotating assembly can be shut down until the minimum acceptable operational speed is reached. The rotational inertia is then sufficient to maintain sufficient rotational speed of the magnets for acceptable performance of the machine over a substantially large period. This may employ minor input power to maintain synchronization of the magnets.

Alternatively, at 1108, rather than using a rotating permanent magnet, the same function is implemented using an electro-magnet wound around a carbon core infused with graphene, with electrical connections similar to the “brushes” used in DC motors configured to slide around two circular or elliptical metal rings (one for the +connection and one for the −connection of the electro-magnet coil) connected to a high current DC power supply to provide the current for the electromagnet and where the DC power supply may be a “homopolar generator” that provides very high currents at relatively low voltages.

### Summary of Exemplary Components and Systems

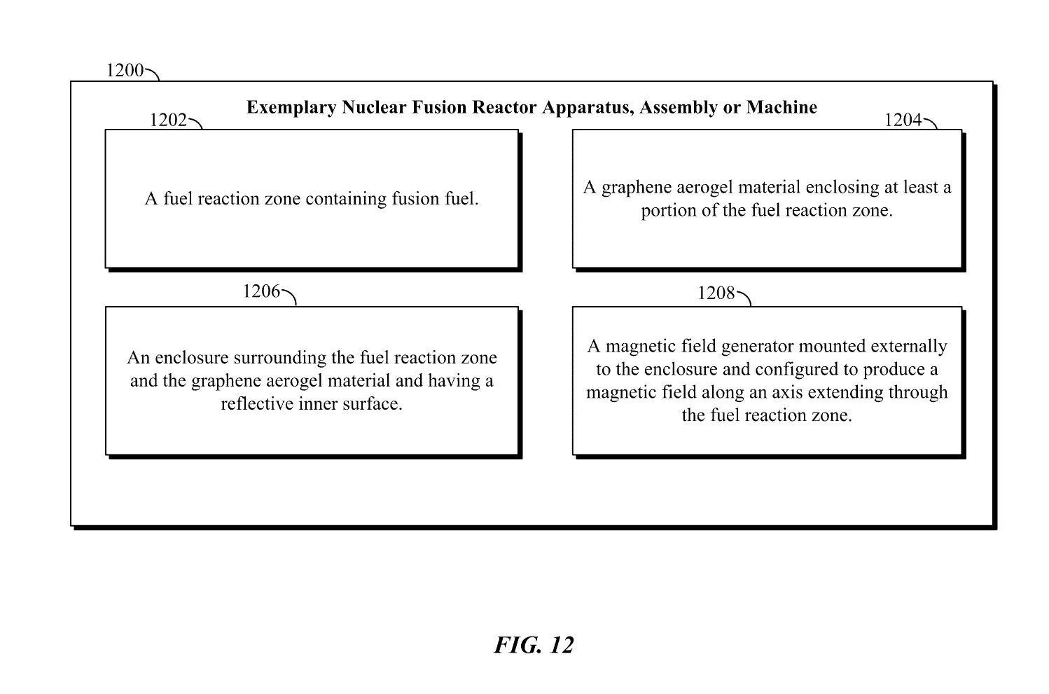

FIG. 12 broadly summarizes components and systems of an exemplary nuclear fusion reactor apparatus 1200. The apparatus includes: a fuel reaction zone 1202 containing fusion fuel; a graphene aerogel material 1204 enclosing at least a portion of the fuel reaction zone; an enclosure 1206 surrounding the fuel reaction zone and the graphene aerogel material and having a reflective inner surface; and at least one magnetic field generator 1208 mounted externally to the enclosure and configured to produce a magnetic field along an axis extending through the fuel reaction zone.

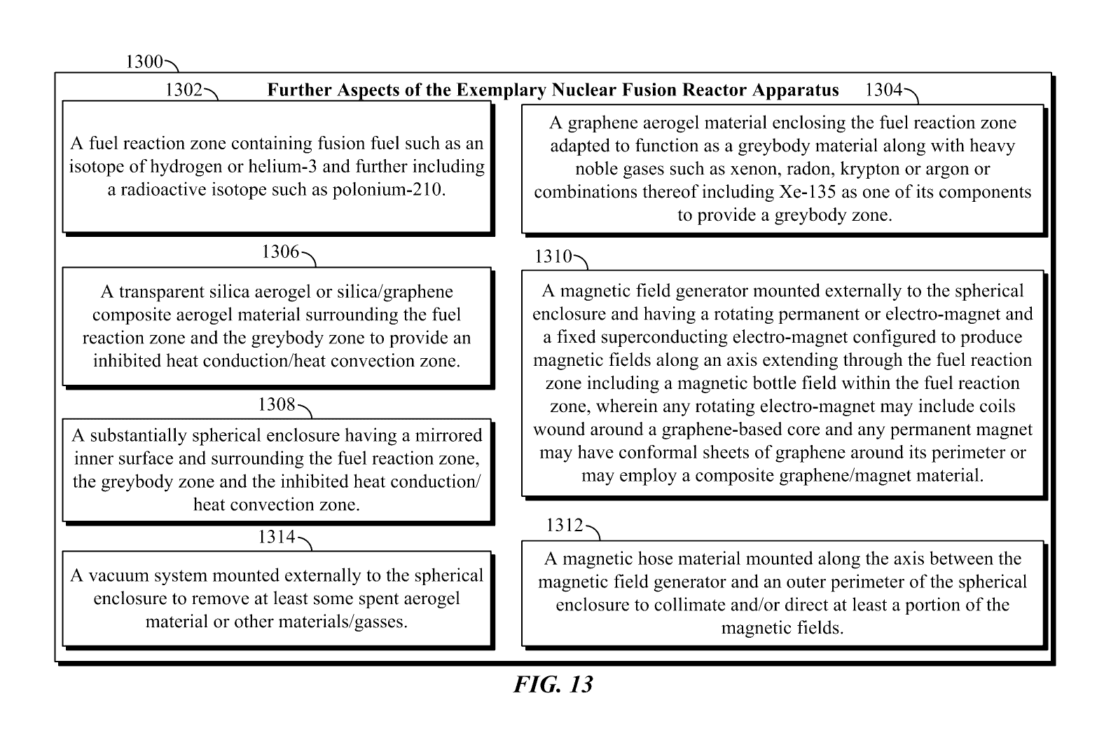

FIG. 13 illustrates and summarizes further aspects of the components and systems 1300 of the exemplary nuclear fusion reactor apparatus of FIG. 12. A fuel reaction zone 1302 is provided that contains fusion fuel such as an isotope of hydrogen or helium-3 and further including a radioactive isotope such as polonium-210. A graphene aerogel material 1304 is provided that encloses the fuel reaction zone and is adapted to function as a greybody material along with heavy noble gases such as xenon, krypton or argon or combinations thereof to provide a greybody zone. A particular isotope of xenon, Xe-135 can be used as a component of the heavy noble gases and has some attractive features for initiating the fusion reaction and absorbing low-energy neutrons. A transparent silica aerogel or silica/graphene composite aerogel material 1306 is provided that surrounds the fuel reaction zone and the greybody zone to provide an inhibited heat conduction/heat convection zone. A substantially spherical enclosure 1308 is provided having a mirrored inner surface that surrounds the fuel reaction zone, the greybody zone and the inhibited heat conduction/heat convection zone. A magnetic field generator 1310 is provided that is mounted externally to the spherical enclosure and has a rotating permanent magnet or electro-magnet and a fixed superconducting electro-magnet configured to produce magnetic fields along an axis extending through the fuel reaction zone including a magnetic bottle field within the fuel reaction zone, wherein any rotating electro-magnet used within the generator may include coils wound around a graphene-coated core and any rotating permanent magnet used within the generator may employ a composite graphene/magnet material. A magnetic hose material 1312 is provided that is mounted along the axis between the magnetic field generator and an outer perimeter of the spherical enclosure to collimate and/or direct at least a portion of the magnetic fields. A vacuum system 1314 is provided that is mounted externally to the spherical enclosure to remove at least some spent aerogel material or other materials or gasses.

The various features of the invention described herein can be implemented in different systems without departing from the invention. It should be noted that the foregoing embodiments are merely examples and are not to be construed as limiting the invention. The description of the embodiments is intended to be illustrative, and not to limit the scope of the claims. As such, the present teachings can be readily applied to other types of methods and apparatus and many alternatives, modifications, and variations will be apparent to those skilled in the art. Note also that the term “including” as used herein is intended to be inclusive, i.e. “including but not limited to.”

What is claimed is:

1. A nuclear fusion reactor apparatus, comprising:
a fuel reaction zone; and
a graphene aerogel material enclosing at least a portion of the fuel reaction zone.

2. The nuclear fusion reactor apparatus of claim 1, wherein the graphene aerogel material is adapted to function as a greybody material.

3. The nuclear fusion reactor apparatus of claim 1, wherein the graphene aerogel material is configured for one or more of adsorbing at least one heavy noble gas or segregating fuel and at least one heavy noble gas.

4. The nuclear fusion reactor apparatus of claim 1, wherein the heavy noble gas comprises one or more of radon, xenon, krypton and argon.

5. The nuclear fusion reactor apparatus of claim 1, further comprising a substantially spherical enclosure with a reflective inner surface surrounding the fuel reaction zone and the graphene aerogel material.

6. The nuclear fusion reactor apparatus of claim 1, further comprising a magnetic field generator having at least one rotating magnet and at least one fixed electro-magnet, the magnetic field generator mounted external to the graphene aerogel material and the fuel reaction zone and configured to produce a magnetic field along an axis extending through the fuel reaction zone.

7. The nuclear fusion reactor apparatus of claim 6, wherein the magnetic field generator is configured to establish at least one magnetic bottle-like field within the fuel reaction zone.

8. The nuclear fusion reactor apparatus of claim 6, wherein the at least one fixed electro-magnet includes superconducting coils and wherein the rotating magnetic is integrated with a substantially large moment of inertia cylinder.

9. The nuclear fusion reactor apparatus of claim 6, further comprising a magnetic hose material along the axis to collimate and position at least a portion of the magnetic field.

10. The nuclear fusion reactor apparatus of claim 1, wherein the fuel reaction zone and the greybody zones include radioactive isotopes.

11. The nuclear fusion reactor apparatus of claim 10, wherein the radioactive isotopes includes one or more of polonium-210 and xenon-135.

12. The nuclear fusion reactor apparatus of claim 1, further comprising a vacuum system operative to remove at least some of the graphene aerogel material

13. A nuclear fusion reactor system, comprising:
a plurality of individual nuclear fusion reactor apparatus, each comprising
a fuel reaction zone; and
a graphene aerogel material enclosing at least a portion of the corresponding fuel reaction zone of the individual nuclear fusion reactor apparatus.

14. The nuclear fusion system of claim 13 with at least one magnetic field generator installed between pairs of adjacent nuclear fusion reactor apparatus.

15. The nuclear fusion system of claim 13, wherein the individual nuclear fusion reactor apparatus are arranged in a loop.

16. A method for obtaining energy from nuclear fusion using a nuclear fusion reactor apparatus having a fuel reaction zone, comprising:
initiating a nuclear fusion reaction within the fuel reaction zone to generate energy;
passing at least some of the energy through a graphene aerogel material enclosing at least a portion of the fuel reaction zone; and
heating a material external to the graphene aerogel material using the energy passed through the graphene aerogel material.

17. The method of claim 16, wherein the material external to the graphene aerogel material that is heated is pressurized water and wherein the method further includes transporting the heated pressurized water to a separate location.

18. The method of claim 16, further including a preliminary step of providing a heavy noble gas within the graphene aerogel material.

19. The method of claim 18, wherein the heavy noble gas comprises one or more of radon, xenon, krypton and argon.

20. The method of claim 16, wherein initiating a nuclear fusion reaction within the fuel reaction zone includes applying a magnetic field to the fuel reaction zone that includes both static and dynamic magnetic field components.
